(19) United States
(12) Patent Application Publication
(10) Pub. No.: US 2016/0110784 A1
(43) Pub. Date: Apr. 21, 2016

(54) WEB-BASED ELECTRONIC CONTROLLED SUBSTANCE TRANSFER MANAGEMENT SYSTEM AND METHOD

(71) Applicants: Penny Hendrix, Belton, TX (US); David Kessler, Temple, TX (US); Daniel Volney, Temple, TX (US)

(72) Inventors: Penny Hendrix, Belton, TX (US); David Kessler, Temple, TX (US); Daniel Volney, Temple, TX (US)

(21) Appl. No.: 14/922,589

(22) Filed: Oct. 26, 2015

Related U.S. Application Data
(63) Continuation of application No. 13/563,057, filed on Jul. 31, 2012.
Application No. 13/563,057 is a continuation-in-part of application No. 12/698,881, filed on Feb. 2, 2010, now abandoned.
(60) Provisional application No. 61/514,638, filed on Aug. 3, 2011.
(60) Provisional application No. 61/149,367, filed on Feb. 3, 2009.

(51) Int. Cl. G06Q 30/06; H04L 29/06; H04L 29/08

(52) U.S. Cl. CPC G06Q 30/0607; H04L 67/02; H04L 67/42; G06Q 30/0635; H04L 63/04

(57) ABSTRACT

A Web-based Electronic Controlled Substance (CS) Transfer Management System and Method designed to fully comply with the DEA requirements for a prescription of controlled substances. The system and method allows the buyer to securely order and confirm the receipt of the controlled substances over an existing Internet infrastructure of the buyer such as a Web browser as the buyer's software, thus avoiding the necessity of any additional proprietary software or hardware to be built and installed onto the buyer's computer. The system and method further utilizes various validation functions, related to signing the controlled substance prescription with the utilization of the PKI certificate therefore, completely eliminating the necessity of the paper DEA 222 Form. The transfer of the controlled substances is managed through a secured database server, wherein signed validated orders are posted for fulfillment and reporting to the DEA.

### CROSS-REFERENCE TO RELATED APPLICATIONS

This application is a continuation of U.S. application Ser. No. 13/563,057 filed Jul. 31, 2012, which claim priority to U.S. Provisional Application No. 61/514,638 filed Aug. 3, 2011. U.S. application Ser. No. 13/563,057 is also a continuation-in-part of U.S. application Ser. No. 12/698,881 filed Feb. 2, 2010, which claims priority to U.S. Provisional Application No. 61/149,367 filed Feb. 3, 2009. Each of the above patent applications is incorporated herein by reference in its entirety to provide continuity of disclosure.

### TECHNICAL FIELD

The present invention relates generally to an ordering and management system and method and, more particularly, to web-based secure ordering system and method associated with electronic transfer of controlled substances subject to DEA regulations.

### BACKGROUND OF THE INVENTION

Numerous industry systems and methods are used by manufacturers and distributors for transmission of their customer's orders electronically. These electronic ordering systems provide a more efficient manner of placing orders that may have previously been submitted by phone, fax, or mail. With electronic ordering, orders may be placed by the Internet using a structured system such as Electronic Data Interchange (EDI).

An EDI system enables businesses to exchange business documents—such as purchase orders, invoices, and order status updates—automatically and electronically, eliminating the need for manual processes.

Electronic ordering allows data to be sent and received 24 hours a day. Because electronic ordering allows business to continue outside the normal business day the turnaround time for a business transaction can be significantly reduced.

However, when these transactions involve controlled substances such as narcotics, Drug Enforcement Agency (DEA) regulations require that the shipper verify the recipient's Federal DEA Certificate and an authorization form signed by the recipient. Such systems have been prohibited from electronically transmitting controlled substance orders without the order also being submitted on the DEA paper 222 Form or an electronic counterpart of that form, created and verified by a certified Controlled Substance Ordering System (CSOS).

### SUMMARY

It is desirable to create a DEA-compliant CSOS managed entirely in a Web environment and without the necessity for the buyer to implement intrusive and expensive additional software or hardware. The CSOS is configured to utilize the buyer's existing Internet infrastructure. Embodiments of the present invention are directed to systems and methods that are further described in the following description and claims. Advantages and features of embodiments of the present invention may become apparent from the description accompanying drawings and claims.

One embodiment of the present disclosure provides a CSOS. This ordering system may include a Web site operable to manage data and communications among DEA-registered parties who transfer controlled substances from one fulfilling party to another requesting party, a first Web browser on a first computer operable to connect the requesting party with the Web site through a signer client (first user) interface, the first user interface having access to a Federal Information Processing Standards' certified (FIPS-certified) digital certificate store and FIPS-certified cryptographic functions capable of applying a digital signature to a controlled substance transfer request, a second Web browser on a second computer operable to connect the fulfilling party with the Web site through a receiver client interface, a signature validation system operable to ensure that the digitally signed message meets DEA security and authorization requirements for transferring controlled substances, one or more Web servers operable to host a centralized version of the Web site and the signature validation system accessible by multiple requesting and fulfilling parties, a database server, and a network interface associated with an external agency validation system. The signer client interface may be hosted on a first network or Internet site and accessible through a browser such as a Microsoft Internet Explorer. This signer client interface may have security management and digital signing functions available therein. The security management functions may involve the use of a Public-key Infrastructure (PKI) certificate management or other like proper security. The receiver client interface may also be hosted on a network or Web site and accessible through a second browser. Although not necessarily required, the second browser may have security management and digital signing functions associated with it as well.

The one or more Web servers may support: the signer client interface and the receiver client interface, generation of orders for controlled substances, digital signature validation functions, secure communication of orders for controlled substances to one or more databases, and both the maintenance and reporting functions associated with individual or aggregated orders. The database server allows signed, validated orders to be posted for storage fulfillment and reporting. The interface with an external agency validation system, which may include a certificate revocation list, may be made through a secure connection between one or more of the Web servers and the validation system. The secure connection to the external agency validation system may be a Lightweight Directory Access Protocol (LDAP) connection or other like connection known to those having skill in the art.

Additional functions of the controlled substance transfer system may involve the management of relationships among signers and receivers, as well as the generation of the controlled substance transfer request otherwise known as an electronic controlled substance prescription subject to DEA regulations for Controlled Substance e-Prescribing, which may further involve the generation of unique prescription documents and the proper maintenance and reporting functions of these prescriptions. Such maintenance and reporting functions may involve the storage fulfillment and reporting of properly signed and validated prescriptions.

Embodiments of the present disclosure provide a Web-based electronic system associated with creating, signing, validating, tracking, and reporting electronic orders associated with controlled substances. This system may be agnostic to users, wherein specific hardware requirements and installation of software modules is not required by either the signer or the receiver. Rather both signers and receivers may access this electronic controlled substance transfer system via a Web browser and through the use of a digital certificate that may be stored independently in the user's Web browser.

Embodiments of the present invention allow the generation of electronic orders or prescriptions for controlled substances in the simplest, most cost-effective way and are the solutions for eliminating paper forms required for controlled substance orders and prescriptions, and for ensuring DEA compliance. The Web-based e-prescribing add-on function of one of the embodiments of the present invention allows the requesting party to prescribe controlled substances without major changes to the current e-prescribing software.

Yet, in another embodiment of the present invention, the CSOS is configured to allow the first user interface for signing multiple controlled substance transfer request using multiple digital certificates through a single access of the FIPS-certified digital store.

In accordance with yet another embodiment of the present invention, the signature validation system is invoked through a batch process that allows validation of multiple digitally-signed messages in a single pass. The batch process function of the CSOS is configured to: (a) utilize a FIPS validated security module to digitally sign electronic form 222; (b) utilize FIPS-approved signature and hash algorithms, RSA, SHA1 and SHA2, when digitally signing electronic form 222; (c) store a private key on the FIPS validated cryptographic module per DEA requirements and the FIPS implementation guidance; (d) utilize the FIPS validated security module when verifying signature of digitally signed electronic form 222; (e) utilize FIPS-approved signature and hash algorithms, RSA, SHA1 and SHA2, when verifying the signature of digitally signing the electronic form 222; and (f) utilize the security module(s) in FIPS mode.

In accordance with yet another embodiment of the present invention, the architecture of the CSOS application allows the functions associated with the supplier of the controlled substance to be executed on a remotely located server that is leased by the supplier as opposed to a server owned by the supplier and physically located at the supplier's premises. The purpose is to destroy the impression that a physical barrier is required to keep one supplier's information separate from another supplier. This step is important to CSOS becoming widely adopted because most small suppliers do not have capability of running their own highly secure Web server.

In accordance with yet another embodiment of the present invention, the architecture of the CSOS application has taken the system to a “cloud computing” model, wherein the impression that virtual separation could not have been achieved without physically separating copies of the software has been destroyed. Such modification in the architecture of the system will result in all suppliers running under a single copy of the software on a single server (or bank of servers). Such modification may further prompt the DEA to mandate that all buyers use CSOS instead of an alternative paper system.

In addition to a controlled substance ordering system, the embodiments of the present disclosure may involve a Web-based secure controlled substance transfer management method, comprising the steps of: (a) accessing a Controlled Substance Ordering System (CSOS) via existing Internet infrastructure; (b) creating an electronic form 222; (c) reviewing and approving the electronic form 222; (d) invoking a signing function of the CSOS by utilization of a PKI certificate through a first user interface having access to a PKI key browser's store; (e) transmitting the electronic form 222; (f) invoking a signature validation system of a digitally signed electronic form 222; and (g) reporting the electronic form 222 controlled substance sale to DEA.

In addition to a controlled substance ordering system, the embodiments of the present disclosure may be applied to medical records or like types of information. One embodiment provides a medical records storage and retrieval system. This medical records storage and retrieval system may include a client interface, one or more Web servers, a database server, and a network interface with a validation system. The client interface may be hosted on a network site by the one or more Web servers. This client interface may have security and digital sign functions such as that discussed with reference to the CSOS.

The one or more Web servers may: manage relationships among parties wishing to securely share access to medical records; generate, sign, and request to post or retrieve medical records; perform digital signature validation functions; securely communicate medical records; and track these items such that proper maintenance and reporting functions on the medical records are made. The database located on one or more database servers may allow for the signed and validated medical records to be posted for storage and retrieval. An interface within the validation system and the one or more Web servers may establish a secure connection in order to validate any posting or request or medical records.

Yet another embodiment provides an information exchange system. This information exchange system may include the client interface, one or more Web servers, one or more database servers, and a secure connection between the Web servers and a validation system. The Web servers host a client interface in the form of network or Web site accessible through a browser. This client interface has security management and digital signature functions. The server may also manage relationships among parties wishing to exchange information or records. These records may for example be private, classified, proprietary information, or other public and non-public information wherein it may be desirable to track access to and maintain control of the integrity of that information. This allows the records and records request to be securely communicated to a database server. Information requests may be generated and signed prior to the posting and retrieving records. Additionally digital signature validation functions may be performed prior to posting or retrieving of records. The Web server may also allow maintenance or recording functions associated with the information contained and the access to the records.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates one embodiment of the basic environment in which the controlled substance transfer system operates.

FIG. 2 illustrates how the underlying architecture of the controlled substance transfer system supports a controlled substance e-prescribing application in addition to a CSOS application.

FIGS. 3A-3C illustrate how the embodiments of the present disclosure solve the scenario which a digital signature must be applied to multiple documents (in batch mode) in addition to applying the digital signature to one document at a time.

FIGS. 4A-4E illustrate the batch mode solution to the problem illustrated in FIGS. 3A-3C provided by embodiments of the present disclosure.

FIG. 5 illustrates a controlled substance order being placed by Buyer 204 to Supplier 202.

FIGS. 6A-6B show that prior to implementation of the embodiments of the present disclosure, the controlled substance order involved a manual process of filling out the DEA paper Form 222 (FIG. 6B).

FIG. 7 illustrates that DEA-approved embodiments of the present disclosure allow the manual paper process to be replaced with a digital certificate or signature so controlled substance orders are facilitated by a secure Web method.

FIG. 8 illustrates the basic architecture for placing orders for controlled substances via the Web in accordance with embodiments of the present disclosure.

FIG. 9 illustrates details of the e222 Creation process in the Data Flow Diagram in FIG. 8 in accordance with embodiments of the present disclosure.

FIG. 10 provides details of the e222 Mgmt process in the Data Flow Diagram in FIG. 8 in accordance with the embodiments of the present disclosure.

FIG. 11 provides the original context level Data Flow Diagram that illustrates at the highest level how embodiments of the present disclosure may work.

FIG. 12 provides details of Order Processing System of FIG. 11, further illustrating the information flow within the order processing system provided by embodiments of the present disclosure.

FIG. 13 provides details of Data Flow Process 1.1 of FIG. 12, further illustrating how an online order is created in accordance with embodiments of the present disclosure.

FIG. 14 provides details of Data Flow Process 1.1.1 of FIG. 13, further illustrating the process of creating, signing, and validating an order in accordance with the embodiments of the present disclosure.

FIG. 15 provides details of Data Flow Process 1.1.3 of FIG. 13, further illustrating the interface between the new Web-based ordering system and the existing legacy order processing and fulfillment system in accordance with embodiments of the present disclosure.

FIG. 16 provides details of Data Flow Process 1.4 of FIG. 12, further illustrating the results of the automated reporting process in accordance with embodiments of the present disclosure.

FIG. 17 provides a screenshot of the login page of an online ordering system as provided by embodiments of the present disclosure.

FIG. 18 provides a screenshot of the available options to a controlled substance order signing user after the user has successfully logged in via the login page shown in FIG. 17.

FIG. 19 provides a screenshot within an online ordering system of a link to a feature for creating orders interactively in accordance with embodiments of the present disclosure.

FIG. 20 provides a screenshot of an online ordering system order being created interactively in accordance with embodiments of the present disclosure.

FIG. 21 provides a screenshot of the final order disposition page from which the signer elects to transmit the order to the receiver in accordance with embodiments of the present disclosure.

FIGS. 22A-22B provide a screenshot wherein a popup 2202 is used to show a list of locally installed digital certificates from which the signer selects one to be used to sign the order in accordance with embodiments of the present disclosure.

FIGS. 23A-23B provide a screenshot of the signer's Web browser requesting the signer to enter a password allowing the locally installed digital certificate to be used to digitally sign the order in accordance with embodiments of the present disclosure.

FIG. 24 provides a screenshot of the results of the digital signature validation process and preliminary order confirmation in accordance with embodiments of the present disclosure.

FIG. 25 provides a screenshot of the order confirmation in the form of an electronic form 222 produced by system in accordance with embodiments of the present disclosure.

FIG. 26 provides a screenshot of the controlled substance order receiver/supplier's options in accordance with embodiments of the present disclosure.

FIG. 27 provides a screenshot of the supplier's shipping status update function of electronic form 222 in accordance with embodiments of the present disclosure.

FIG. 28 provides a screenshot detailing the response from the DEA reporting system upon automated transmission of daily reports about shipped controlled substances in accordance with embodiments of the present disclosure.

FIG. 29 provides logic flow diagram associated with the process of placing an order for a controlled substance in accordance with embodiments of the present disclosure.

### DETAILED DESCRIPTION

Embodiments of the present invention are illustrated in the FIGs., like numerals being used to refer to like and corresponding parts of the various drawings.

Embodiments of the present invention allow electronic controlled substance orders to be placed using software programs that have been approved as controlled substance ordering systems (CSOS). Typically, this software is implemented in a controlled substance supplier's location. However, the software has been designed to operate in a variety of deployment scenarios, including (1) on a Web server, virtual or physical, remotely located at the Web hosting provider's location for the supplier, and (2) on a dedicated provider's server, with the software operating as a service under a “private cloud computing” model. This software includes functionality to digitally sign the purchase order using the purchaser's CSOS digital certificate issued by the DEA. A CSOS Certificate may be installed into multiple software programs and may be transferred to multiple ordering computers.

Prior embodiments of electronic controlled substance reporting systems are typically part of a larger overall framework of Business-to-Business (B2B) applications. These systems do not provide a stand-alone single-source application capable of operating agnostically with various computing platforms. Further, these existing systems require the installation of various unique software modules on the signer system, and require hardware and various unique software modules in the receiver infrastructure in order to support the electronic transactions associated with controlled substances.

Embodiments of the present disclosure provide a Web-based electronic system associated with creating, signing, validating, tracking, and reporting electronic orders associated with controlled substances. This system may be agnostic to users wherein specific hardware requirements and installation of software modules is not required by either the signer or the receiver. Rather both signers and receivers may access this electronic CSOS processing system via a Web browser and through the use of a digital certificate that may be stored independently in the user's Web browser.

Embodiments of the present invention provide an architecture where controlled substance order functions are implemented using the existing Internet infrastructure. This solution evolved out of a need for an alternative to existing commercially available Controlled Substance Ordering System (CSOS) software that would be simpler to implement and less intrusive into both the signer's and the receiver's existing IT environment. If suppliers (receivers of controlled substance orders and paper Forms 222) cannot or will not implement existing commercially available CSOS software, then the CSOS initiative is of no use to the pharmaceutical industry supply chain or the DEA.

Embodiments of the present invention may provide Signer/Receiver FIPS 140-2 Level 1 validated security modules being invoked in FIPS mode to prove that the FIPS approved cryptographic algorithms are actually being utilized. The DEA requires that the security module used to digitally sign and/or verify the digital signature of controlled substance orders must be FIPS 140-2 Level 1 validated. These embodiments have physically demonstrated digital signature, transmission, and signature verification through a series of tests designed to prove that embodiments can successfully sign, transmit, receive, and verify orders.

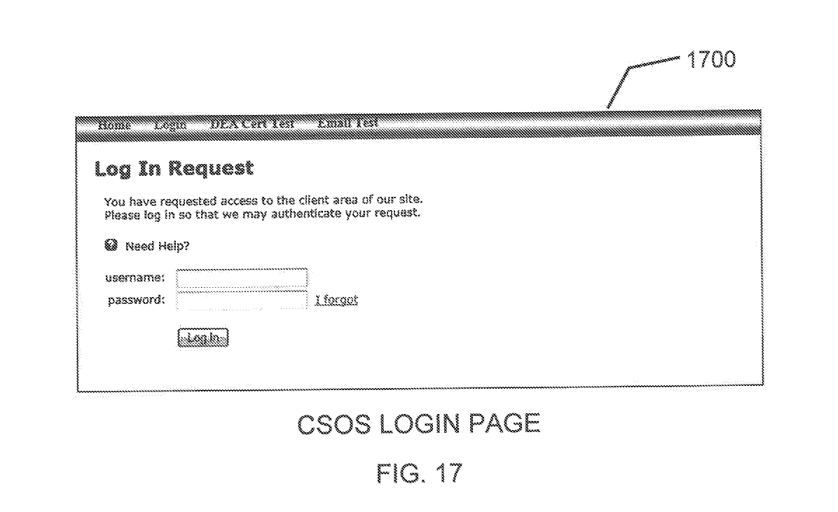

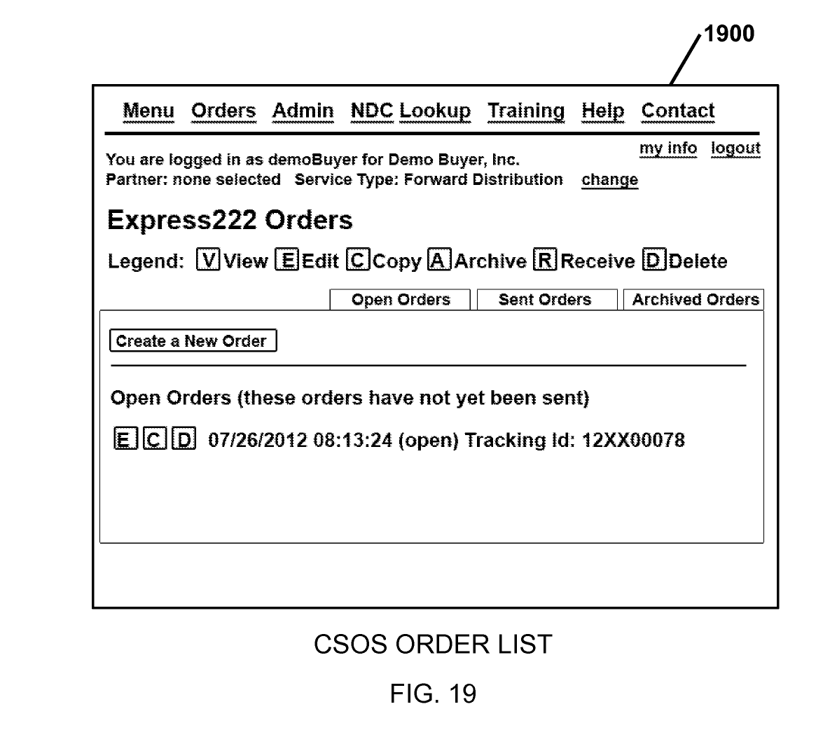

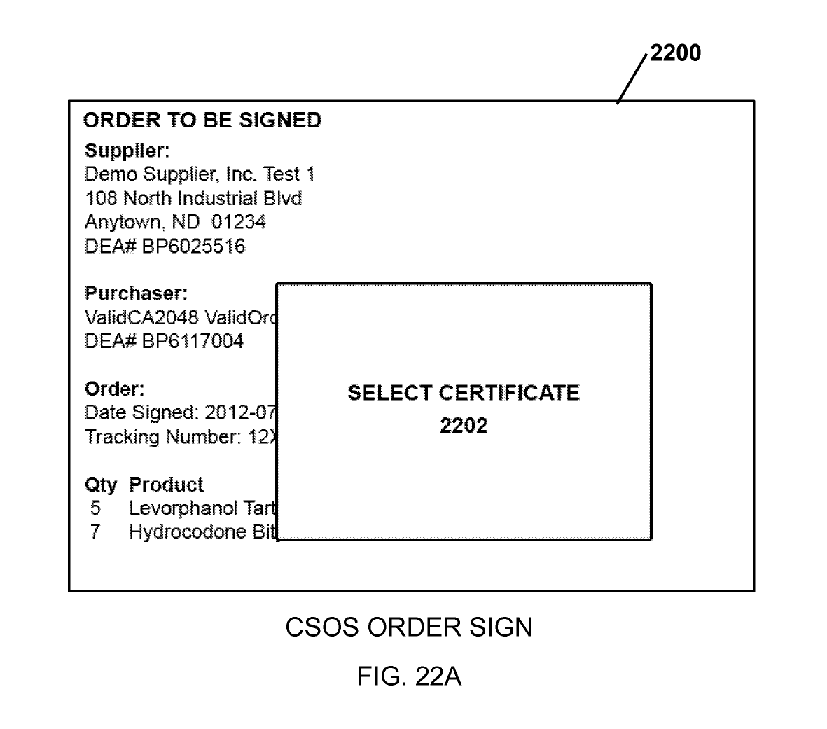

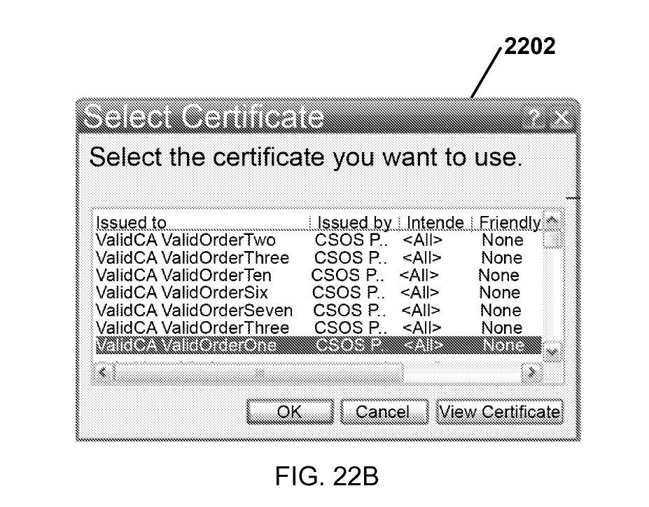

Embodiments logically support both signer (also referred to herein as a buyer/purchaser, or a requesting party) and receiver components (also referred to herein as a supplier, or a fulfilling party), but may be designed and implemented as a Web-based application utilizing a Web browser as the ordering, approving, and signing client. Orders are built and signed by the Purchaser by remotely accessing a Web application using a Web browser. Access to the provider's CSOS application via the Internet utilizes a Secure Hypertext Transfer Protocol Secure (HTTPS) for over-the-wire encryption to ensure data privacy, and to provide the Purchaser with confirmation that the Supplier site is legitimate through the normal (Secure Socket Layer) SSL handshaking protocols. The Purchaser must have an account at the server side (Supplier) of the application, and will be challenged to provide login credentials consisting of a username and password to gain access to the CSOS ordering system. (FIG. 17). The Purchaser is responsible for obtaining their digital certificate(s) from the DEA, and the provider's CSOS application requires that Purchasers follow the DEA instructions for storing the digital certificate(s) in their local browser's certificate key store. After logging onto the provider's CSOS web application using the Internet browser, the Purchaser creates an order and submits it to the Supplier-side of the Web application. (FIGS. 19-21). If the Supplier-side determines that the order contains controlled substances, the software will require the Purchaser to digitally sign the order. The browser will ask the user to select a certificate from the browser's key store, and the user will be challenged to input the private key password in order to use the certificate to sign the order. (FIG. 22A-22B). The signing page of the Web application utilizes Javascript to invoke the digital signing procedure calls via a custom Microsoft ActiveX control wrapper around the Microsoft CryptoAPI library.

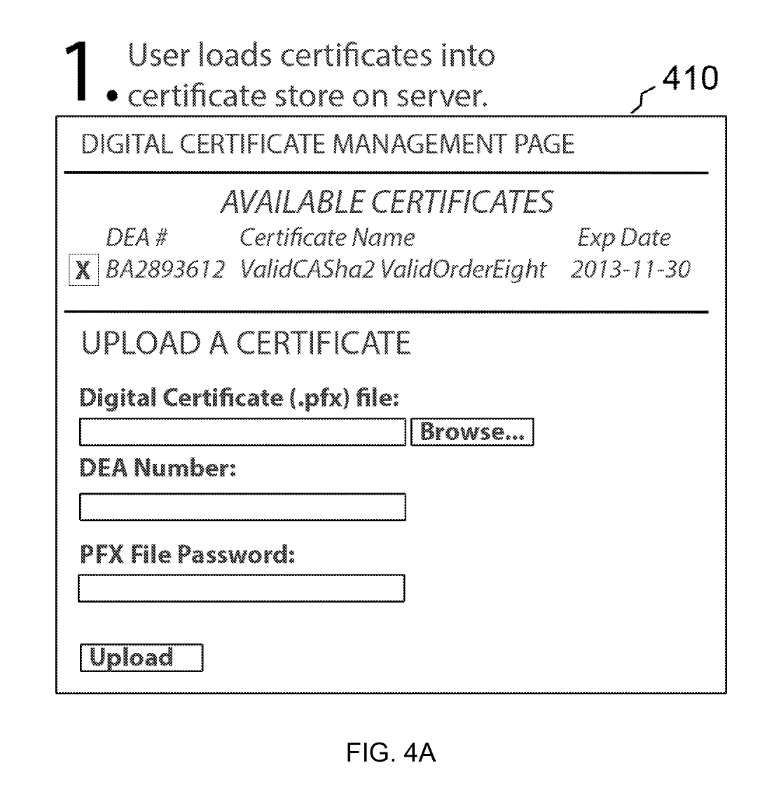

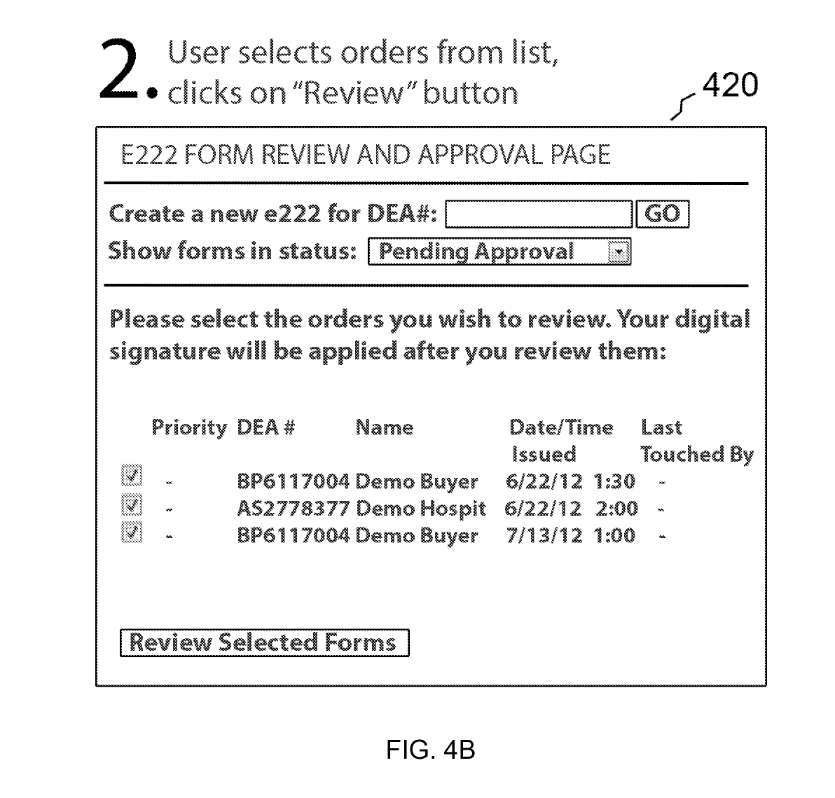

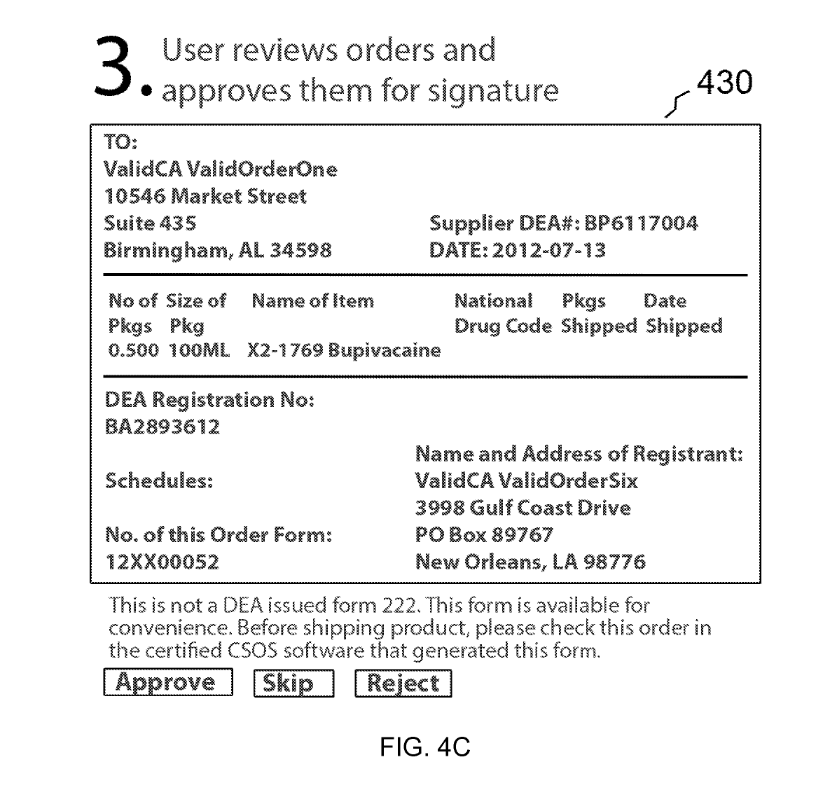

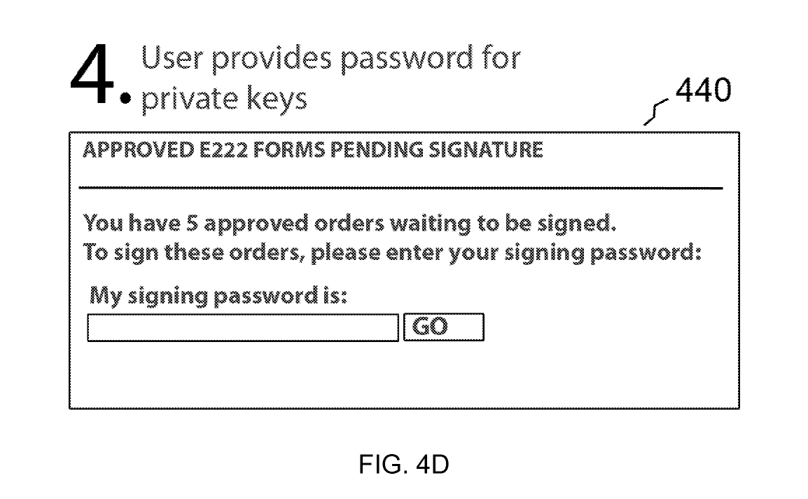

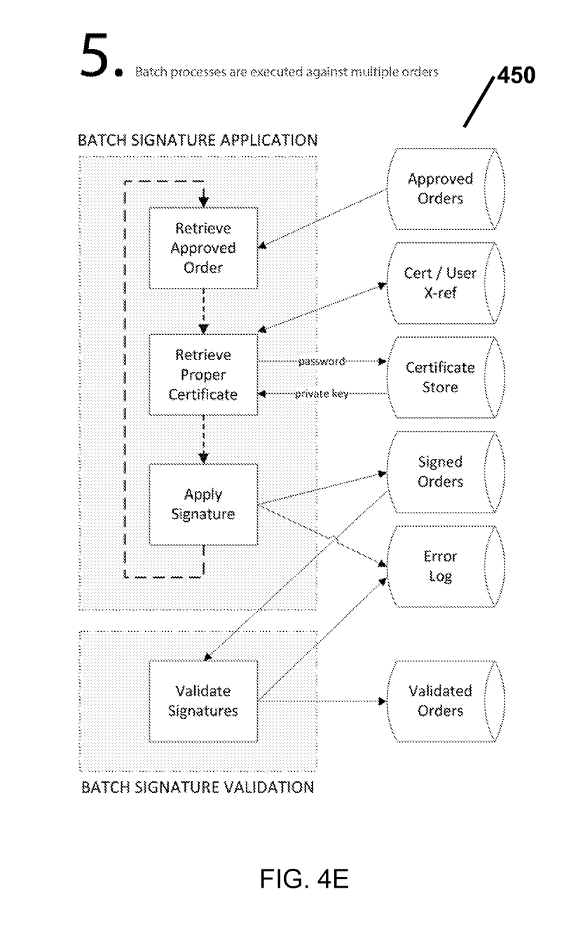

In addition to the single-signer browser-based Purchaser client, embodiments of the present disclosure provide a solution for reverse distributors and self-distributing mass retail chains, which sign hundreds of orders in a short period of time and must manage thousands of Power of Attorney (POA) signing certificates. (FIGS. 4A-4E) Selecting the certificate for each order one-at-a-time is not feasible for these users, and an alternative signer configuration allows certificates to be stored on the server so they can be automatically selected after the user reviews and approves a batch of orders and enters the private key password. (FIG. 4E) All the approved orders are signed by a server-side signer function before being submitted to the Supplier-side of the web application.

Both the browser-based signer component and the server-side batch signer component (also referred to herein as batch process) were successfully audited for all required and optional features described in the Audit Details section of the CSOS Compliance-Audit-Final Report by Drummond Group, which Audit Details are incorporated herein by reference for all purposes. All applicable Audit Cases were successfully executed using both the 2048 bit SHA1 DEA Test Suite of certificates and the 2048-bit SHA2 DEA Test Suite of certificates.

The Supplier-side of the CSOS application is comprised of five main server application services/functions:
a Web server that hosts the (Hypertext Processor) PHP and Microsoft Dot Net (C#) Web application code, including the signature validation code;
a database server that stores all the order and configuration information for the CSOS application;
a LDAP server that maintains an up-to-date cached copy of the DEA revocation list;
a certificate service for private key storage of certificates for the batch signing process; and
a secure File Transfer Protocol (FTP) server.

Embodiments may provide any combination of the following features which may be required by the DEA:
Signer HIPS Validation Audit;
Receiver FIPS Validation Audit;
Signer Positive Transmission;
Receiver Positive Validation;
Receiver Negative Security Validation;
Receiver DEA Registration Number Validation;
Receiver Order Schedule Validation;
Signer Private Key Storage and Access Passed;
Signer National Institute of Standards and Technology (NIST) Time Synchronization;
Receiver NIST Time Synchronization;
Required Data Fields Present;
Signer Order Linked Records Archival; and
Receiver Order Archival.

For the Purchaser/Signer component, embodiments may physically utilize a FIPS validated security module on the Signer computer system. Since the embodiments require Purchasers to connect to the Supplier using a Web browser, the Web page that facilitates the Purchaser digitally signing the order invokes the operating system's security module using the Microsoft CryptoAPI by a combination of Javascript and a custom ActiveX control installed on the client's Internet browser.

Testing has been performed using a Purchaser/client computer running the Windows XP operating system and the Microsoft Enhanced Cryptographic Provider (RSAENH). Embodiments of the present disclosure may support signers running on various operating systems such as but not limited to Microsoft Windows XP7 or Vista with a number of versions of the Microsoft Enhanced Cryptographic Provider.

The batch Signer component executes on the server-side after the Purchaser reviews and approves one or more orders to be signed using one or more private keys.

Testing of embodiments of the present disclosure confirms that the embodiments:
utilize a FIPS validated security module to digitally sign CSOS Orders (also referred to herein as electronic form 222 or electronic controlled substance prescription);
utilize FIPS approved signature and hash algorithms RSA and SHA1 and SHA2, When digitally signing CSOS Orders;
store the private key on a FIPS validated cryptographic module per DEA requirements and FIPS implementation guidance;
utilize a FIPS validated security module when verifying signature of digitally signed CSOS orders;
utilize FIPS approved signature and hash algorithms, RSA and SHA1 and SHA2, when verifying the signature of digitally signing CSOS Orders; and
utilize the security module(s) in FIPS mode.

Testing regarding Signer Positive Transmission/Receiver Positive Validation revealed that embodiments pass DEA required features that require that:
A CSOS Product acting as a Buyer system be able to digitally sign and transmit CSOS Orders;
A CSOS Product acting as a Supplier system that receives CSOS Orders must be capable of verifying the digital signature applied to the Order; and
Only DEA issued digital certificates can be used to digitally sign CSOS Orders.

When verifying the digital signature on a CSOS Order, the Supplier system must use the public key associated with the message signer's private key. Verification of digital signature confirms that the message was signed with a private key directly associated with the signer's public key and that the contents of the message were not changed or corrupted after the signature was applied.

Testing observed physical demonstration of the process of creating the order including a user logging into the CSOS application and signing the order. The digitally signed order was then transmitted to the Supplier system via the Buyer's Web browser where the order's digital signature was successfully verified. This was demonstrated for both the single-order browser-based signing component, and the multiple-order server-based signing component.

Testing confirmed that embodiments of the present disclosure are physically capable of digital signature and transmission of CSOS Order per DEA requirements and are capable of receiving and verifying digitally signed CSOS Order in compliance with DEA requirements.

With respect to Receiver Negative Security Validation, testing revealed that the embodiments provided this DEA required feature. DEA requires that a CSOS Product acting as a Supplier system must:
determine that an order has not been altered during transmission and invalidate any order that has been altered;
verify the digital signature using the signer's public key and invalidate any order in which the digital signature cannot be validated;
check the Certificate Revocation List (CAL) automatically and invalidate any order with a certificate listed on the CRL; and
check the validity of the certificate and the Certification Authority (CA) certificate and invalidate any order that fails these validity checks.

Testing observed physical demonstration of negative tests designed to prove compliance to these requirements. Embodiments of the present invention were successfully able to demonstrate that orders that failed validity checks were correctly flagged and not made available for further processing.

Embodiments of the present disclosure demonstrated the ability to recognize and correctly act on orders that:
failed content integrity checks;
were signed with a digital certificate not issued by the DEA;
had been revoked through DEA approved processes;
were signed with digital certificates that had expired;
were signed with digital certificates whose associated CA digital certificate had been revoked; and
were signed with digital certificates whose associated CA digital certificate had expired.

Additionally, testing shows that embodiments are capable of automatically recognizing that cached CRL and authority revocation list(s) (ARL) are expired, and automatically retrieving and utilizing the latest CRL and ARL lists from DEA hosted site(s).

As with the Positive Transmission tests, both the 2048 bit SHA1 and SHA2 certificate suites were used to validate the negative audit test cases.

With respect to Receiver DEA Registration Number Validation testing revealed that the embodiments provided this DEA required feature. DEA requires that a CSOS Product acting as a Supplier system must validate that the DEA registration number contained in the body of the CSOS Order corresponds to the registration number associated with the specific certificate by separately generating the hash value of the registration number and certificate subject distinguished name serial number and comparing that hash value to the hash value contained in the certificate extension for the DEA registration number. If the hash values are not equal, the receiving system must invalidate the order.

Testing observed physical demonstration of both positive and negative tests designed to prove compliance to this requirement. Embodiments of the present disclosure were successfully able to demonstrate that CSOS Order with an incorrect DEA Registration number was flagged and correctly reported as failed.

With respect to Receiver Order Schedule Validation, testing revealed that the embodiments provided this DEA approved feature. DEA requires that a CSOS Product acting as a Supplier must check the substances ordered against the schedules that the registrant is allowed to order and invalidate any order that includes substances the registrant is not allowed to order.

Testing observed a physical demonstration of the system rejecting an order that contained a line item for a substance, when the schedule authority as defined by the DEA test certificate in use did not allow for purchase of those substances.

With respect to Signer Private Key Storage and Access, testing revealed that the embodiments provided this DEA approved feature. DEA requires that a CSOS Product acting as a Buyer system must use either a user identification and password combination or biometric authentication to access the private key. Activation data must not be displayed as they are entered. The system must set a 10-minute inactivity time period after which the certificate holder must re-authenticate the password to access the private key and when the signing module is deactivated, the system must clear the plain text private key from the system memory to prevent the unauthorized access to, or use of, the private key.

Testing observed physical demonstration of user sign-on. Testing confirmed that activation data is not displayed, and then confirmed through observation and demonstration that if a user attempts to enter incorrect activation data the user is prevented from signing orders.

Testing observed that the Signer system required the user to enter the password as each individual CSOS Order is signed, in effect third-party user, other than the authorized user who knows the password, could not take advantage of the fact that the authorized user was already signed in even during the DEA mandated 10 minute period. As such the private key is not made available outside of the limited code that directly invokes the FIPS security module.

With respect to Signer/Receiver Environment, testing revealed that the embodiments provided this DEA approved feature. DEA requires that a CSOS Product must have a time system that is within five minutes of the official NIST time source.

Testing observed a physical demonstration that the Receiver/Supplier system environment was in synchronization with NIST provided time sources using synchronization features of the Microsoft Windows Server operating system. The Signer/Buyer system does not use the client system clock to generate/sign orders, since order generation is a web server application running on the server side system. Therefore both the Signer and Receiver systems rely on the server side system clock, which is synchronized with NIST time sources via operating system services.

With respect to Required Data Fields Present, testing revealed that the embodiments provided this DEA approved feature. DEA requires that a CSOS Product must create an order that includes all data fields listed under section 1305.21 (b) of the Regulations. The Regulations describe nine (9) data fields, the format, if applicable and whether or not the data may optionally be supplied by a Buyer-side product.

Testing reviewed and archived several CSOS orders showing that Embodiments provided these data fields. Embodiments utilize an Extensible Markup Language (XML) document format to package and transmit the required data fields between the Buyer and Supplier systems.

With respect to Signer Order Archival/Signer Linked Record Archival testing revealed that the embodiments provided this DEA approved feature. DEA requires that a CSOS Product acting as a Buyer must archive the digitally signed orders and any other records required in 21 C.F.R. Part 1305 of the Regulations, including any linked data.

Testing reviewed the archival methods of the Product, finding that CSOS Orders are archived in both a database management system and can be accessed by the Buyer via username/password access to a private account in the embodiments of the present invention. The Buyer archival system lists all orders generated by the Buyer and whether they had been submitted, not submitted, or rejected by the Supplier. The Buyer can review the details of any of his orders including the order date, the tracking number, and the embodiments order list. In addition, embodiments of the present disclosure are capable of demonstrating archival and retrieval of records linked to the Order including but not limited to information provided by the Supplier such as shipment notification and order rejection.

With respect to Receiver Order Archival, testing revealed that the embodiments provided this DEA approved feature. DEA requires that a CSOS Product acting as a Supplier must archive the order and associate with it the digital certificate received with the order.

Testing reviewed the archival methods of the Product, finding that CSOS Orders are archived in a database management system. In addition, the embodiments of the present invention are capable of demonstrating archival, retrieval and viewing of the digital certificate associated with the CSOS Order as the digital certificate is stored as a part of the CSOS Order.

Overall the embodiments of the present invention respecting the generation of the controlled substance transfer request otherwise known as an electronic controlled substance prescription subject to DEA regulations, meet the following functional requirements set forth in 21 C.F.R. Parts 1300, 1304, 1306, and 1311 for Electronic Prescriptions for controlled Substances:
display of prescriptions ready to be approved by the issuing practitioner;
display of essential prescription data required during approval/signing;
audit and review capabilities to provide visibility into possible system misuse;
monthly prescription log review capabilities;
capabilities for a secondary user other than the practitioner to set up login accounts in the system and grant authority for approving and signing prescriptions;
Digital Signature capabilities for the practitioner using as DEA-issued PKI certificate;
capabilities for the system to apply as PKI digital signature if the practitioner uses an ID authentication token (a cryptographic key stored on a special hardware device, such as a smart card, a USB drive, or a one-time-password device) instead of a PKI certificate; and
two-year minimum archive with query capabilities for practitioner and pharmacy.

Embodiments of the present invention allow secure electronic controlled substance orders without the supporting paper DEA Form 222.

With PKI, a trusted CA issues digital certificates to subscribers after validating their identity and authority. With CSOS, subscribers use these certificates to digitally sign controlled substance orders that are placed using CSOS-enabled ordering software. PKI technology provides the following security services to an electronic ordering system:
(1) Confidentiality—only authorized persons have access to data;
(2) Authentication—establishes who is sending/receiving data;
(3) Integrity—the data has not been altered in transmission; and
(4) Non-repudiation—parties to a transaction cannot convincingly deny having participated in the transaction.

The CSOS process involves: (1) an individual enrolls with DEA and, once approved, is issued a personal CSOS Certificate; (2) the Purchaser creates an electronic 222 order using approved ordering software such as described by the embodiments. The order is digitally signed using the Purchaser's personal CSOS Certificate and then transmitted to the Supplier. The paper Form 222 is completely eliminated from the ordering process; (3) the Supplier receives the purchase order and verifies that the Purchaser's certificate is valid with DEA. Additionally, the Supplier validates the electronic order information just like a paper order; (4) the Supplier completes the order and Ships to the purchaser. Any communications regarding the order are sent electronically; and (5) the order is reported by the Supplier to DEA within a predetermined period of time.

One embodiment simplifies transactions for the buyer. Another simplifies transactions for the supplier. A third embodiment simplifies transactions for DEA and helps the DEA to meet their long-term goals for CSOS.

In one embodiment, the CSOS application has been implemented on a highly secure physical server at the supplier's premises for a single supplier with multiple buyers. The software was designed to use an Internet Explorer browser as the buying-side software so that no proprietary software would have to be built and installed on the buyer's computer. This allows the tens of thousands of buyers not utilizing CSOS, whom DEA would like to see using CSOS, to more easily use CSOS when their suppliers implement it.

In another embodiment, each supplier-side copy of the CSOS software may be deployed on a virtual server (within one or more physical server(s)). These may be located for example within a third-party data center. This embodiment makes CSOS easier for suppliers, as most small suppliers do not have the capability of running their own highly secure physical server.

In a next embodiment, the CSOS software architecture has been modified to a single-source “software as a service” model to which buyers and suppliers in the supply chain can easily subscribe and use as needed, whether for one transaction or for hundreds of thousands of transactions.

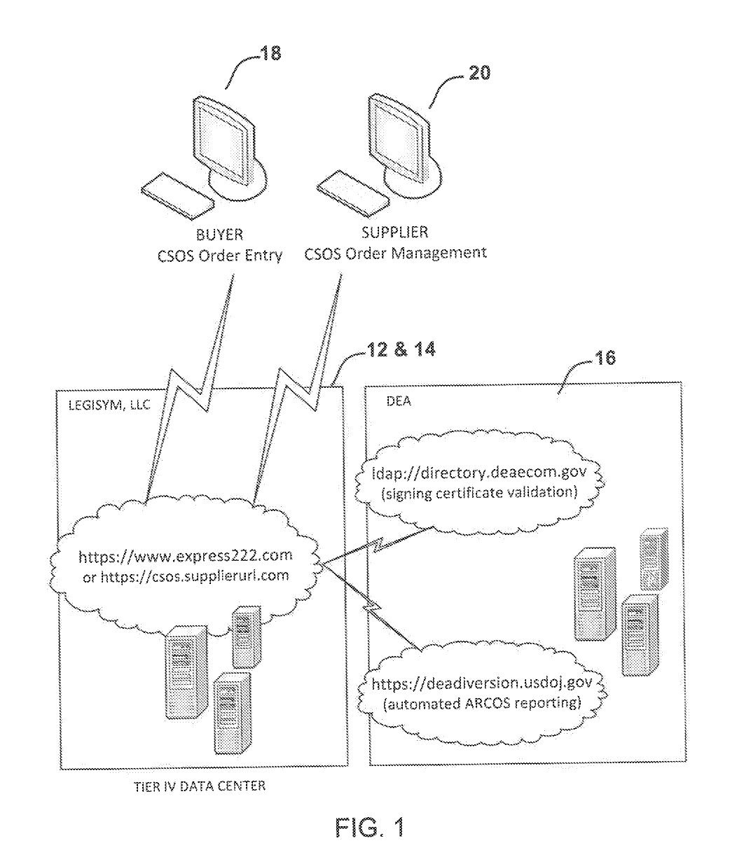

FIG. 1 illustrates one embodiment of the basic environment in which the controlled substance transfer system operates. This environment includes several physical and virtual servers in a highly secure (Tier IV) data center hosting the Provider and Express222 (CSOS) environment 12, and the supplier environment 14. These servers may use a cloud computing model or architecture to present an order entry/buyer interface 18 to network attached users and an order management/supplier interface 20 to network attached users, and to communicate with the DEA servers 16.

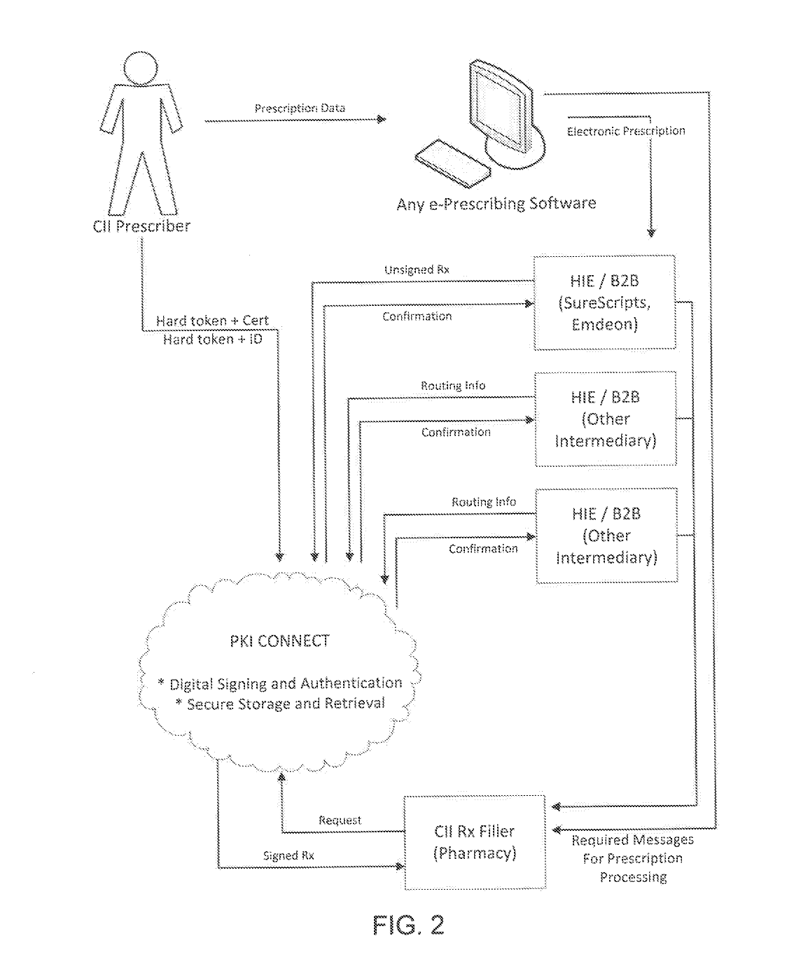

FIG. 2 illustrates how the underlying architecture of the controlled substance transfer system supports a controlled substance e-prescribing application in addition to a CSOS application.

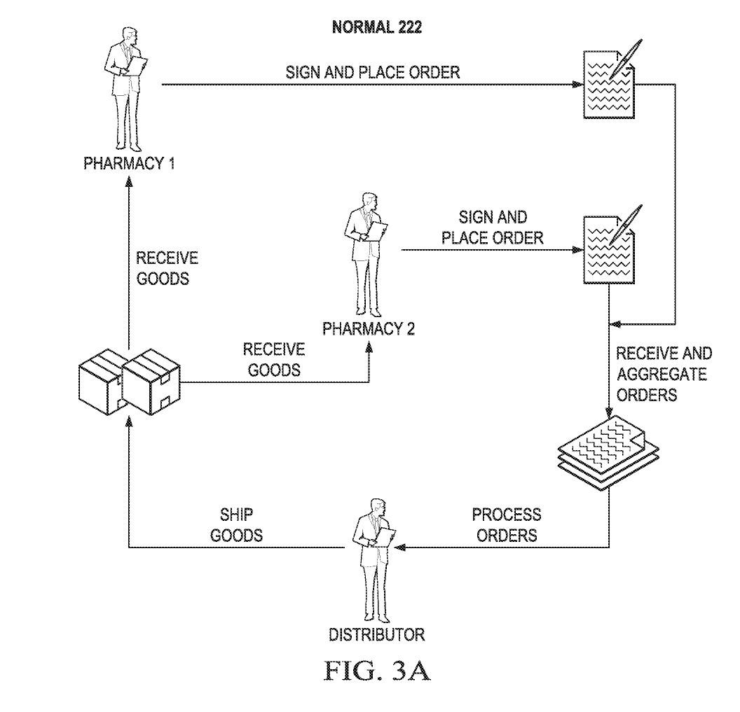

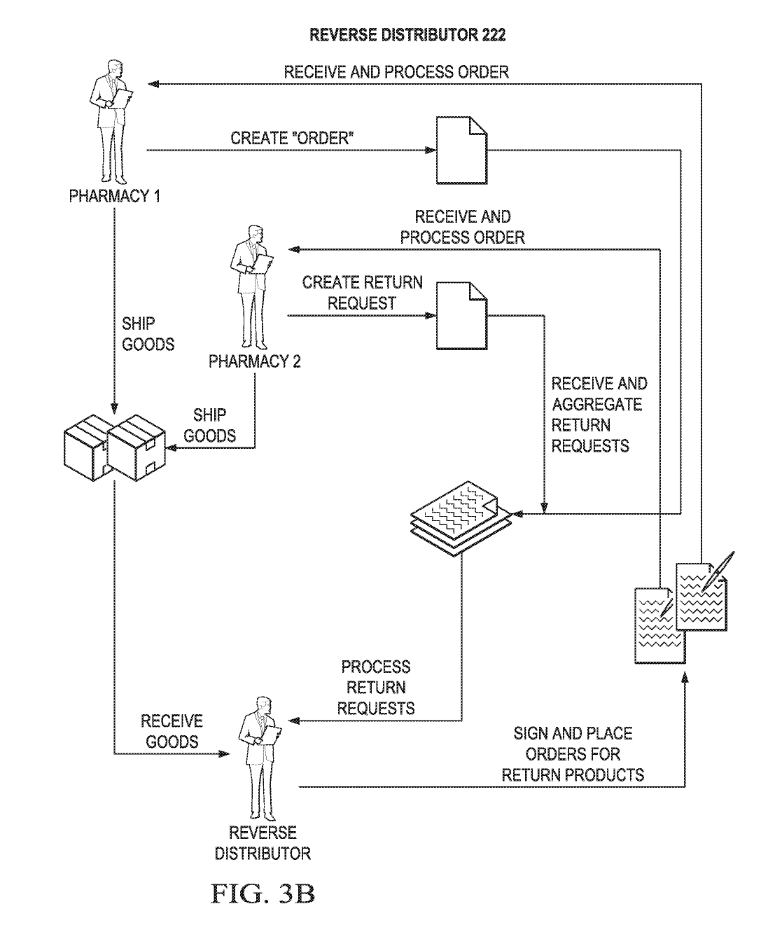

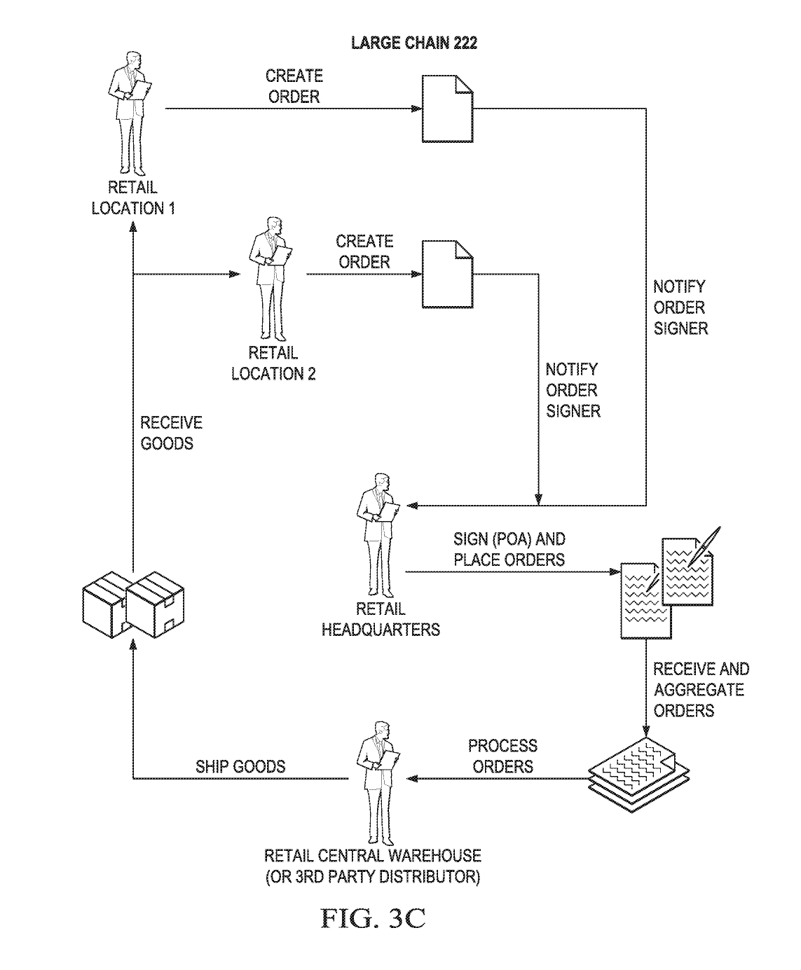

FIGS. 3A-3C illustrates how one embodiment of the present disclosure solves the scenario in which a digital signature must be applied to a single document, but a different embodiment is required to solve the scenario in which multiple documents must be signed at one time. The scenario depicting the problem shows that in a previous setting a single e222 order must be created and signed one-at-a-time, which takes place on the purchaser's computer (FIG. 3A). The order file is transmitted to the purchaser's computer via a Javascript function. It is then signed using an ActiveX control, and is transmitted back to the server. The scenarios depicted in FIGS. 3B and 3C introduce the need for a more efficient process for digitally signing hundreds of e222 orders at one time, as depicted by FIGS. 4A-4E.

FIGS. 4A-4E illustrate the batch mode solution of the problem illustrated in FIGS. 3A-3C where selecting the certificate for each order one-at-a-time is simply not feasible. This solution is particularly practical for reverse distributors and self-distributing mass retail chains, which sign hundreds of orders in a short period of time and must manage thousands of POA digital signing certificates as depicted in FIGS. 3B and 3C. In this embodiment of the present disclosure, the user's digital certificates are stored in a secure certificate store on the server instead of on his local computer, allowing the private key(s) to be applied to multiple orders at once. FIGS. 4A-4B show that the user uploads his password-protected certificates (410) in preparation for using them to sign orders. The user builds a batch by selecting orders from the list of orders waiting to be signed (420), and then reviews and approves the orders individually as required by DEA regulations (430) as in FIG. 4C. Upon completion of the review and approval process, the user provides the password to his private key(s) and submits the approved orders for signature FIG. 4D (440). FIG. 4E illustrates how the batch signature application process selects the appropriate certificate from the user's certificate store and digitally signs each order in succession. The process repeats for every approved order, and each order is updated in the database with the results of the signing attempt. A separate offline batch process runs periodically to pick up the digitally-signed orders and verify that the signatures are valid.

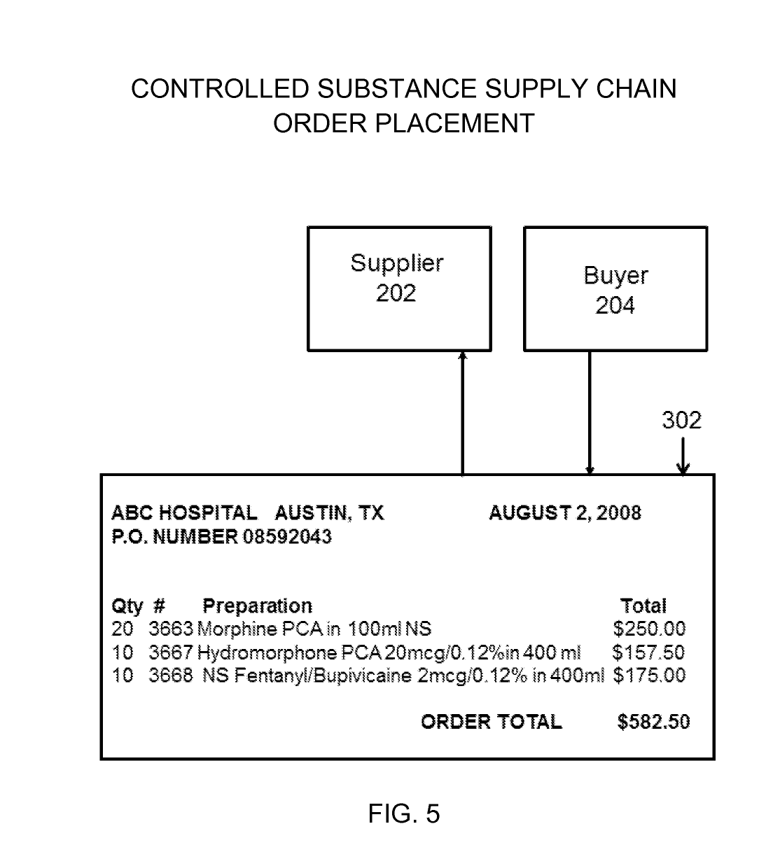

FIG. 5 shows that the various entities in the supply chain such as Buyer 204 may submit normal orders 302 to various entities in the supply chain such as Supplier 202 by phone fax, email or via a secure Web site.

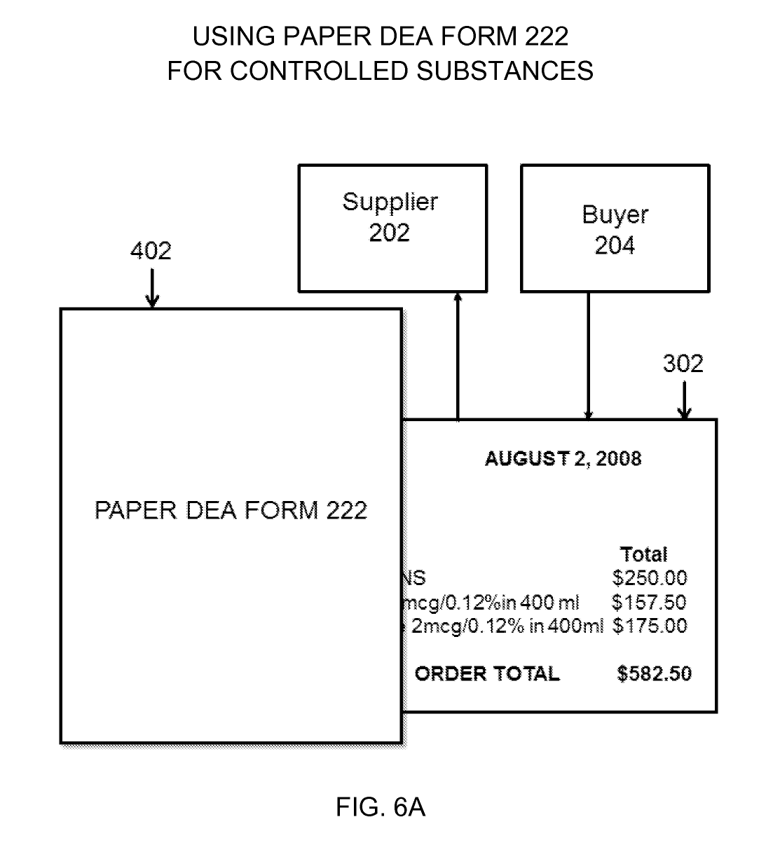

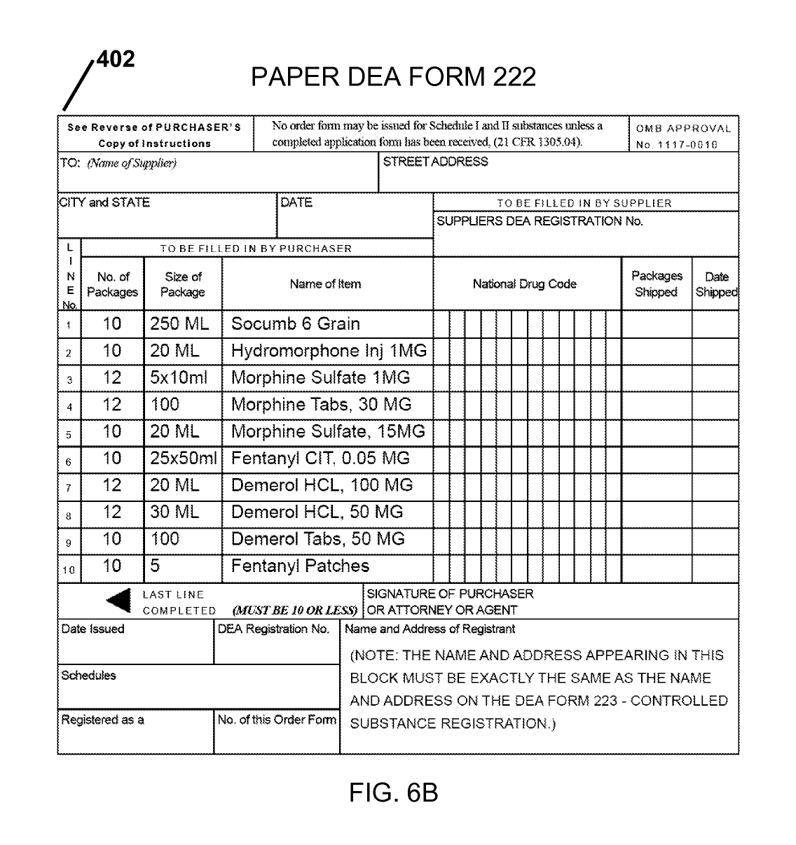

FIGS. 6A-6B provides a block diagram similar to that of FIG. 5. However, in this case, where the orders 302 for pharmaceuticals requested and provided are controlled substances, current guidelines from the DEA require a Form 222 (402) be associated with the controlled substance transaction. Form 222 (402)-FIG. 6B must be signed and physically delivered to the supplier prior to order fulfillment.

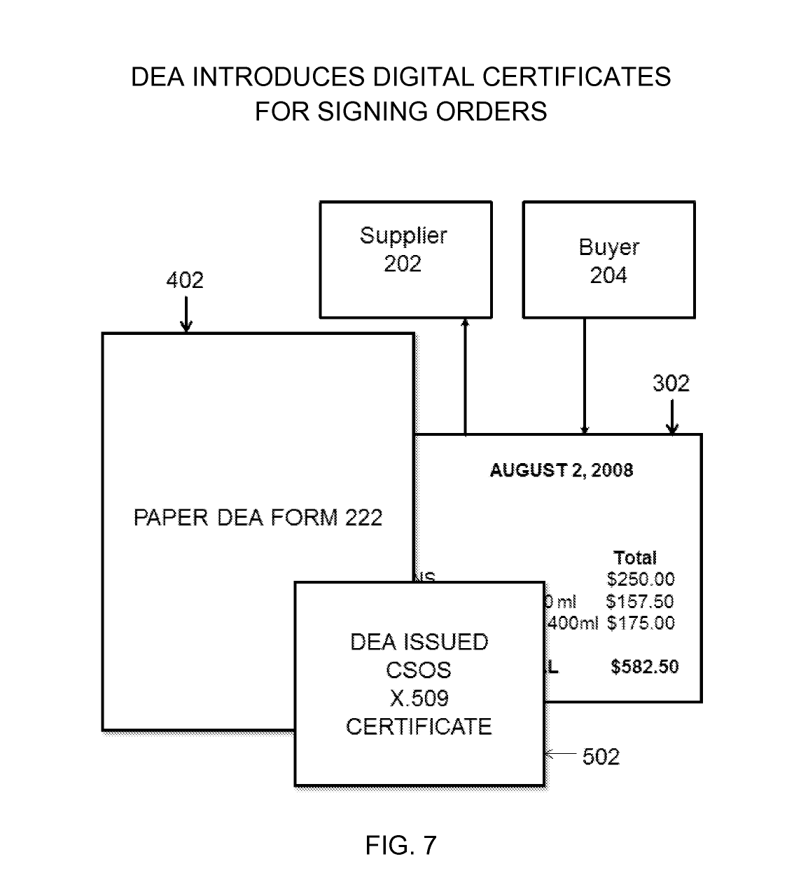

FIG. 7 shows that embodiments of the present disclosure add a digital certificate x.509 that allows an electronic order to be digitally signed with the same level of trust as a wet signature, eliminating the time delay associated with the physical delivery of a paper DEA Form 222. This allows orders to be facilitated by a secure Web method in accordance with embodiments of the present disclosure.

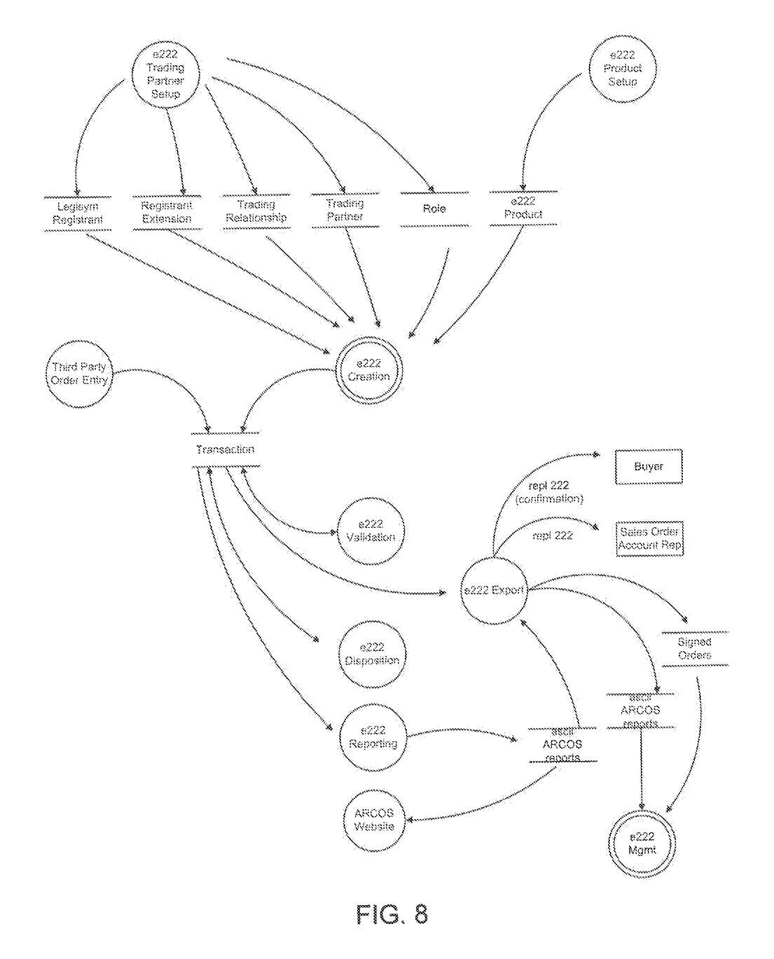

FIG. 8 provides a context level process diagram showing at the highest level how embodiments of the present disclosure may work. FIG. 8 illustrates the overall process of a provider setting up the supplier in the system, the supplier setting up his trading partners (buyers) and controlled substance products, the buyer placing a controlled substance order and using a digital certificate to sign the order, the supplier determining that the digital signature and the controlled substance order are valid, and ensuring that the DEA has not revoked the buyer's digital certificate, the supplier specifying whether the order was shipped or voided, the shipped quantities being reported automatically to the DEA via the ARCOS reporting mechanism, and the supplier managing the order and reporting information supplied by the system.

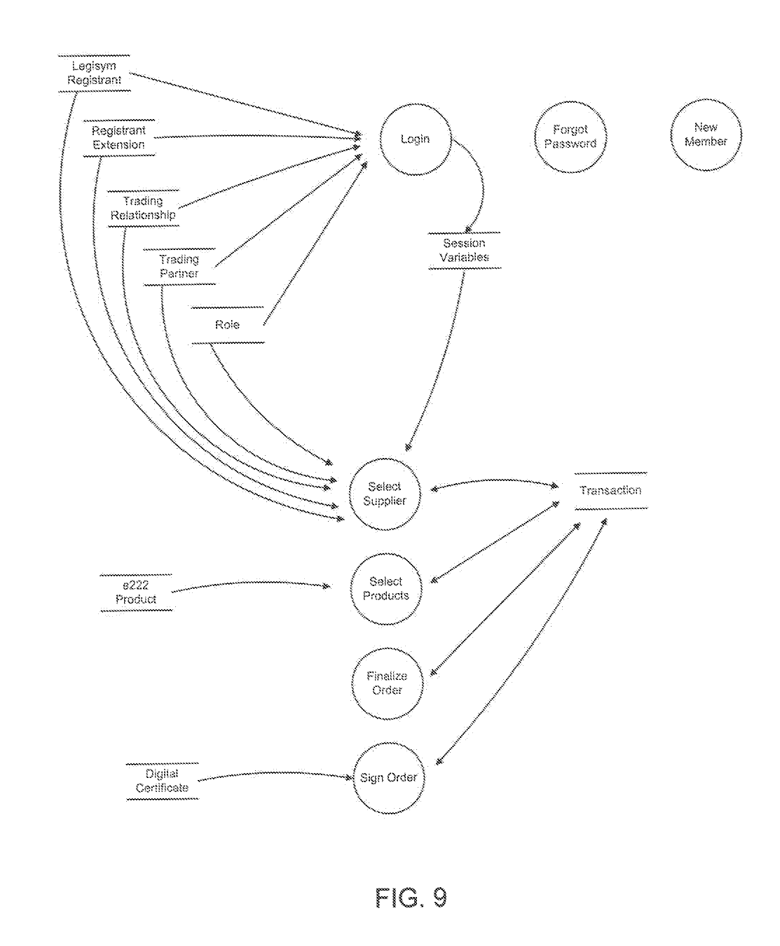

FIG. 9 provides details of the buyer placing a controlled substance order (e222 Creation process in the Data Flow Diagram in FIG. 8) in accordance with embodiments of the present disclosure.

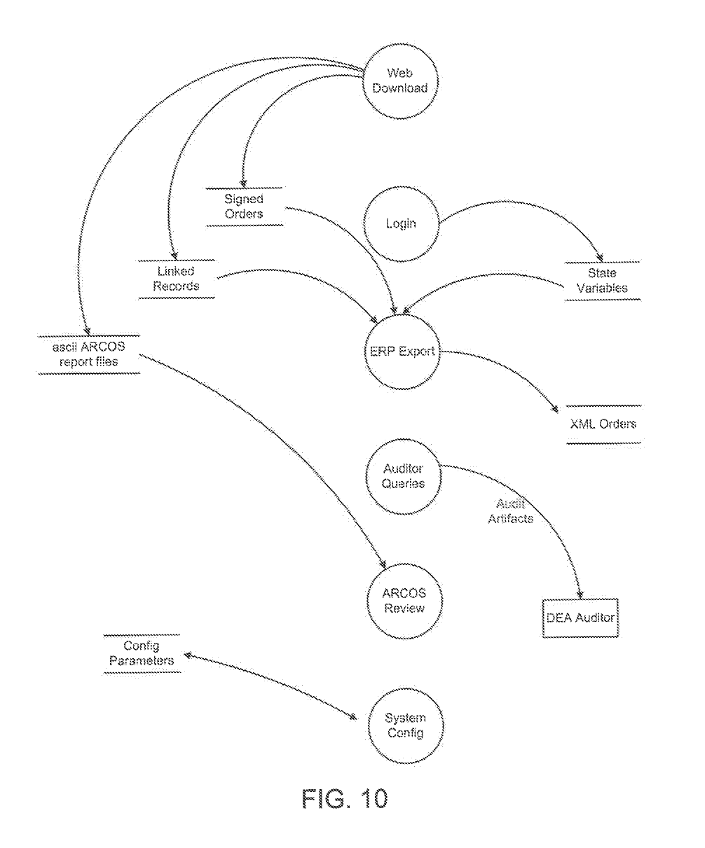

FIG. 10 provides details of the supplier managing the order and reporting information supplied by the system (e222 Mgmt process in FIG. 8) in accordance with the embodiments of the present disclosure.

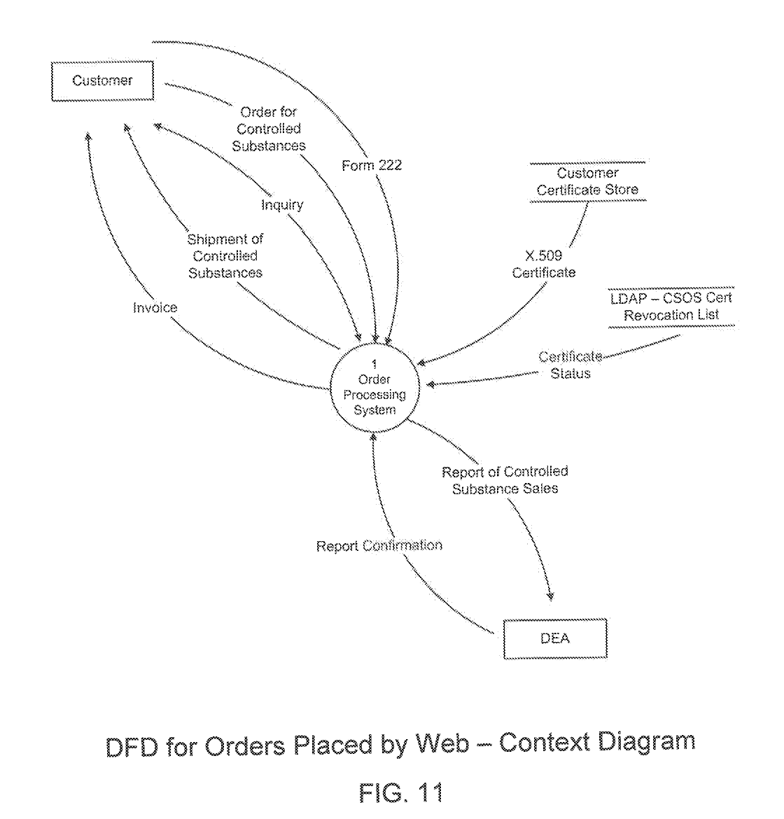

FIG. 11 provides a context level Data Flow Diagram (1100) that illustrates at the highest level how embodiments of the present disclosure may work. FIG. 11 depicts the information flow within the order processing system provided by embodiments of the present disclosure. This Data Flow Diagram shows that data flows from the customer to the system and back as well as from the system to the DEA and back. These orders may be cross-referenced against certificates that may have been revoked in order to ensure that orders using improper, expired, or revoked certificates are not processed. Information received from the customer, as well as a stored certificate from the customer, may be cross-referenced against a controlled substance certificate revocation list, wherein the order processing system verifies the validity of the certificates and the order prior to order fulfillment and facilitates the reporting of controlled substance sales to an external agency such as the DEA.

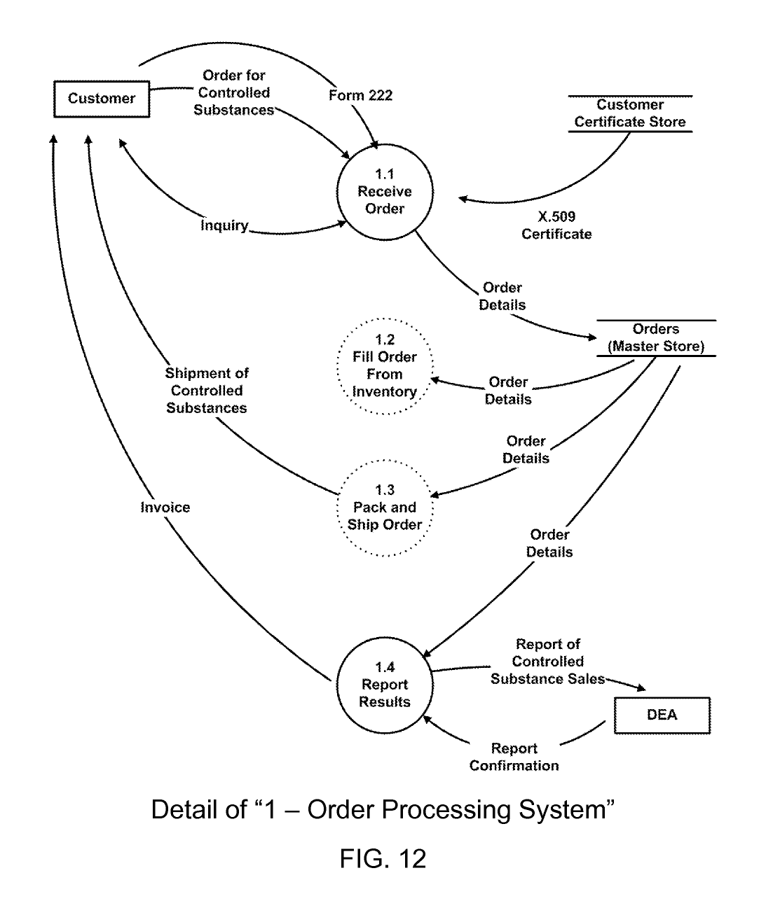

FIG. 12 provides details of Data Flow Process 1 of FIG. 11, further illustrating the information flow within the order processing system provided by embodiments of the present disclosure. FIG. 12 shows that the order processing system consists of four basic processes, Process 1.1 where an order is received, Process 1.2 where an order is filled from inventory, Process 1.3 where an order is packed and shipped, and Process 1.4 where the order details are reported to the external agency. The Process 1.1 and Process 1.4 are primarily involved in the controlled substance certification and reporting.

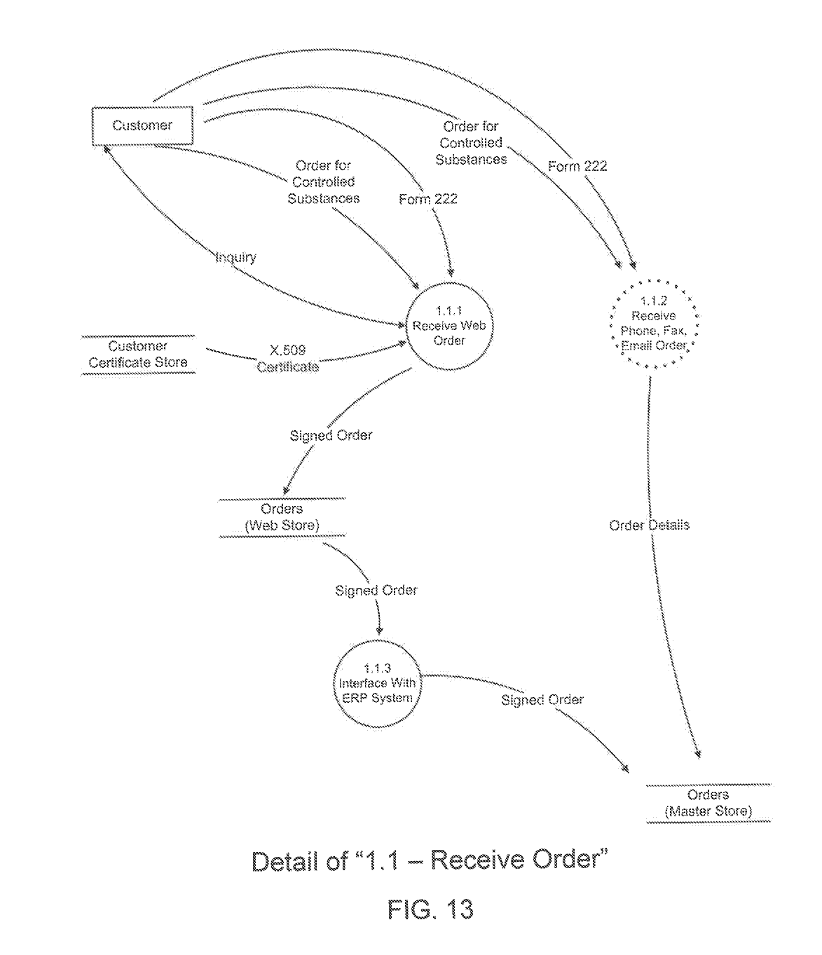

FIG. 13 provides details of Data Flow Process 1.1 of FIG. 12, further illustrating how an online order is created in accordance with embodiments of the present disclosure. As shown, here the orders may be received via a secure link over the Web or, in more traditional means, via phone, email, or fax orders. The Web order along with a digital certificate allows an electronic order for controlled substances to be securely received and digitally signed so that the order may be properly processed.

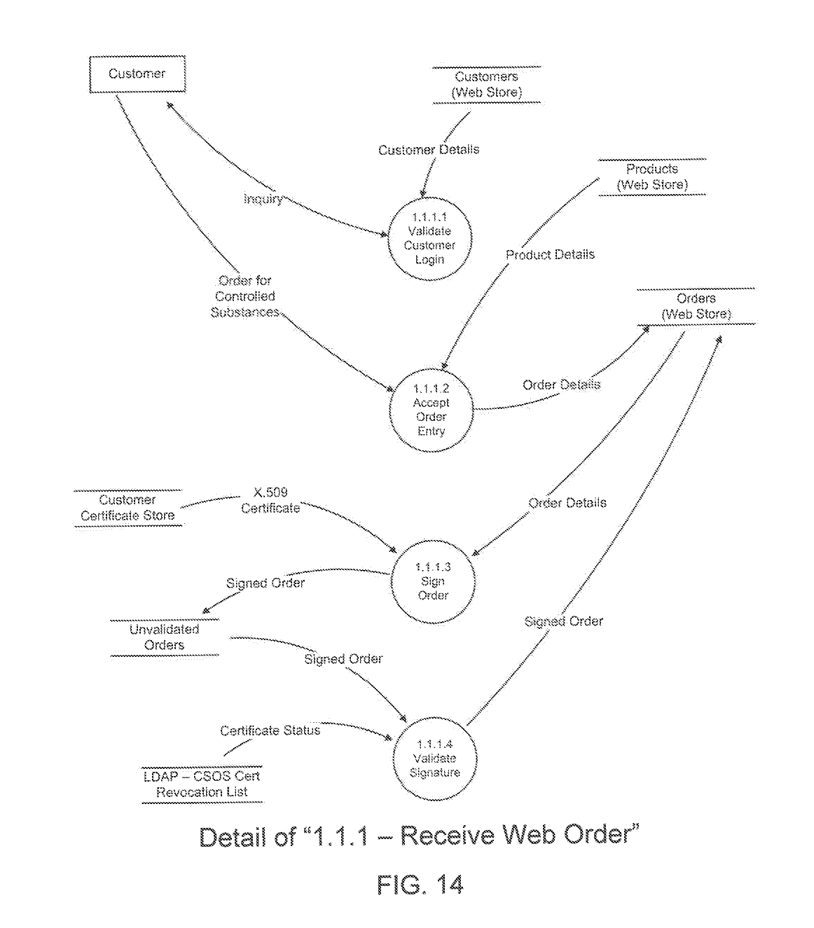

FIG. 14 provides details of Data Flow Process 1.1.1 of FIG. 13, further illustrating the process of creating, signing, and validating an order in accordance with the embodiments of the present disclosure. This data flow diagram further details the process of receiving an electronic or Web-based order for pharmaceuticals, including those with controlled substances. A buyer logs into the site and is validated in Step 1.1.1.1. They navigate to a Web page or a browser window in order to enter an order as indicated by the accept order entry Data Point 1.1.1.2. The order may be identified as an order for controlled substances based on the kinds of items that are ordered. If the order is for a controlled substance, buyers have the ability to use a digital certificate to sign the order as indicated at Data Point 1.1.1.3. This signed order may be stored in the database as an un-validated order, which may be farther processed. The signed order is then validated at Data Point 1.1.1.4 where the validation module verifies the controlled substance certificate with the DEA Agency database to ensure that the certificate status is in good standing. Additionally other administrative checks may be performed on the certificate and the order to ensure it is proper. The signed order may then go into the order's database.

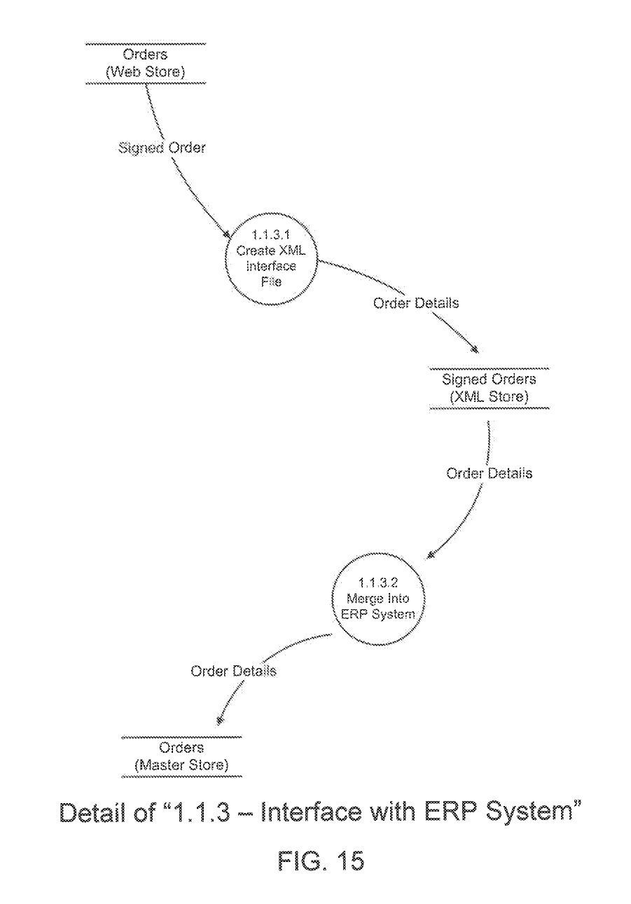

FIG. 15 provides details of Data Flow Process 1.1.3 of FIG. 13, further illustrating the interface between the Web-based ordering system and the existing legacy order processing and fulfillment system in accordance with the embodiments of the present disclosure. This is after the signing and validation of the actual order. The signed order is then communicated as an XML file via a secure data transmission process. This data is merged with all the orders in the database of the main system for processing.

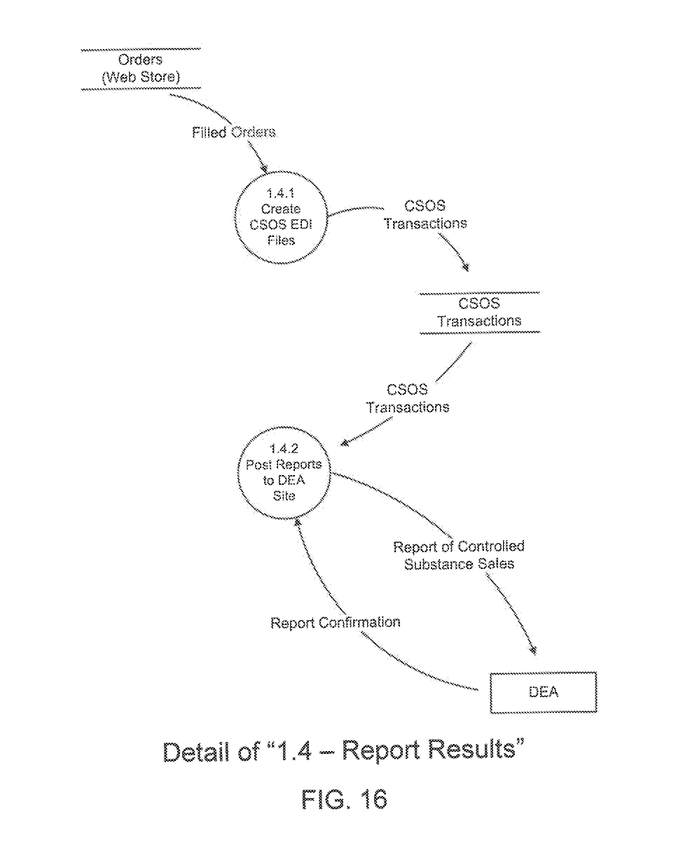

FIG. 16 provides details of Data Flow Process 1.4 of FIG. 12, further illustrating the results of the automated reporting process in accordance with embodiments of the present disclosure. Data Point 1.4 deals with the reporting of results. Electronic orders for controlled substances may be summarized, reformatted, and posted as reports to the agency site. As shown, here the agency may specify reporting requirements that may change over time in order to improve the quality of the reporting of controlled substance sales. This is a completely automated process where the transactions are formatted and sent to the DEA.

FIG. 17 provides a screenshot of the login page of an online ordering system as provided by embodiments of the present disclosure. The user through their browser may log on to an online ordering system via Login Page 1700. After logging in the user may see various available options.

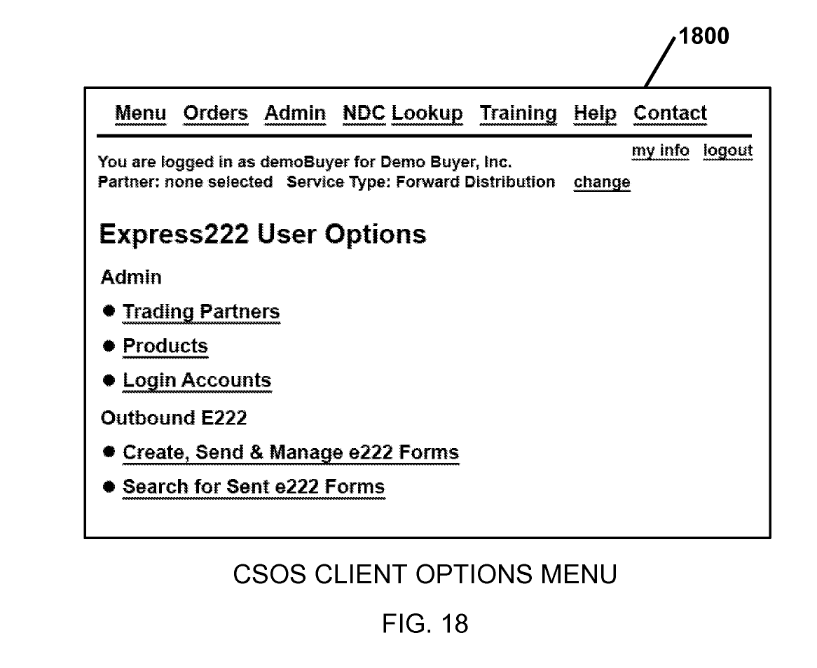

FIG. 18 provides a screenshot of the available options to an order signing user after the user has successfully logged in via the login page shown in FIG. 17 as provided by embodiments of the present disclosure. In this embodiment Page 1800 presents first a menu (Express222 User Options) containing administrative options, outbound order management options, and various other general system options. The primary option of interest in the embodiments of the present disclosure is “Create, Send, and Manage e222 Forms,” which when selected by the user, would result in the screenshot of FIG. 19 being presented.

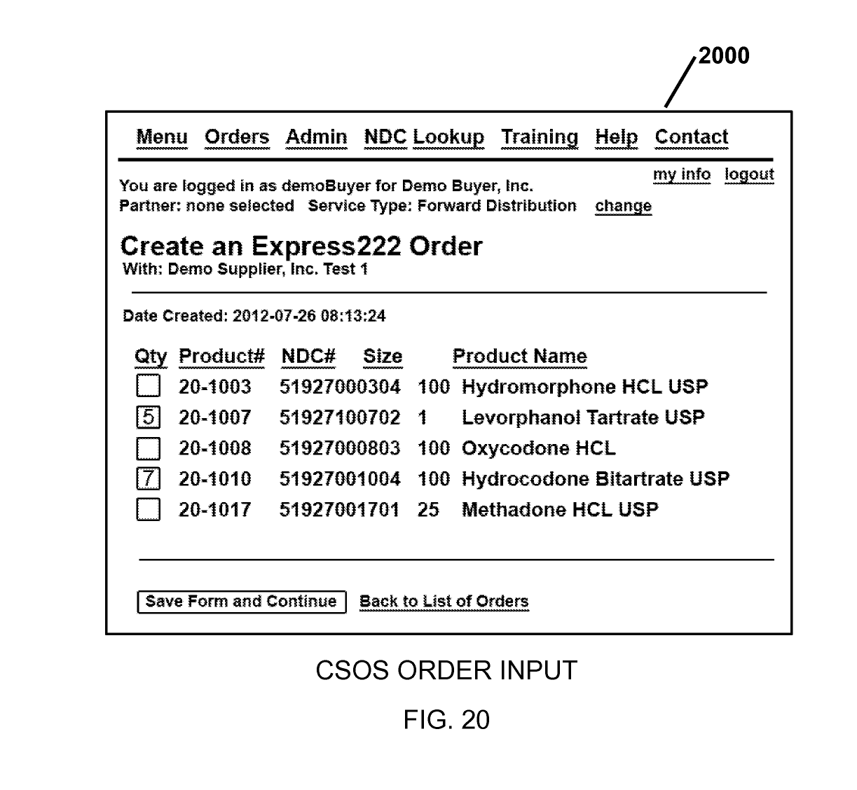

FIG. 19 provides a screenshot 1900 within an online ordering system for editing pending orders or creating new orders interactively in accordance with embodiments of the present disclosure. Screenshot 1900 shows that the page has several tabs that include open order, sent orders, and archived orders. Screenshot 1900 shows the open orders tab where an order with Tracking id: 12XX00078 is in the process of being submitted. If one were to click on the open order, the details of that order would be provided in FIG. 20.

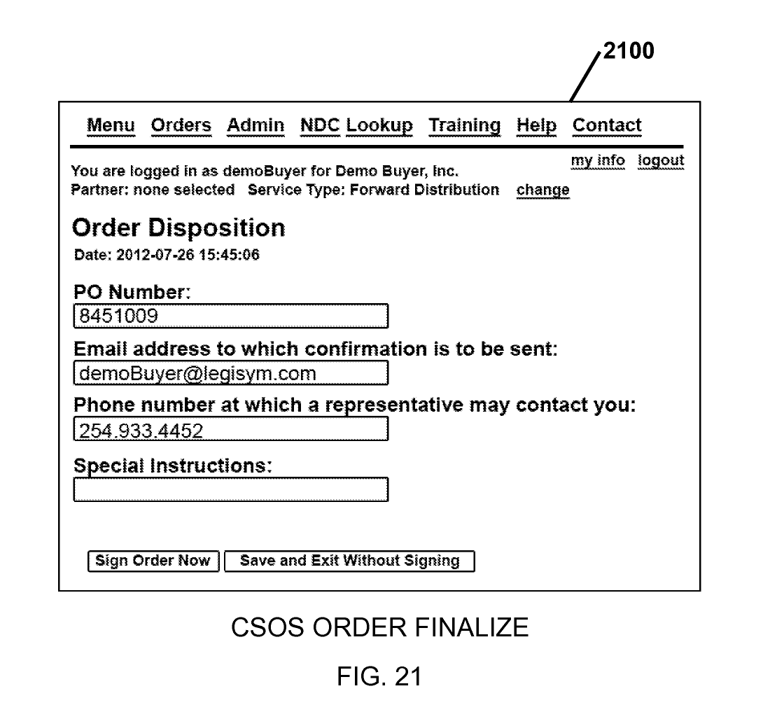

FIG. 20 provides a screenshot 2000 of an online ordering system in which an order is being created interactively in accordance with embodiments of the present disclosure. This screen provides the buyer with five controlled substances, and allows the input of a quantity for each. If the user were to type in some quantities and click on the “Save Order and Continue” button of FIG. 20 the screen shot of FIG. 21 would be presented.

FIG. 21 provides a screenshot 2100 of the final order disposition page from which the signer elects to transmit the order to the receiver in accordance with embodiments of the present disclosure. Here, a user has the option to choose either “Sign Order Now” or “Save and it Without Signing.” If they chose “Sign Order Now” button the screenshot 2200 associated with FIG. 22 will be presented.

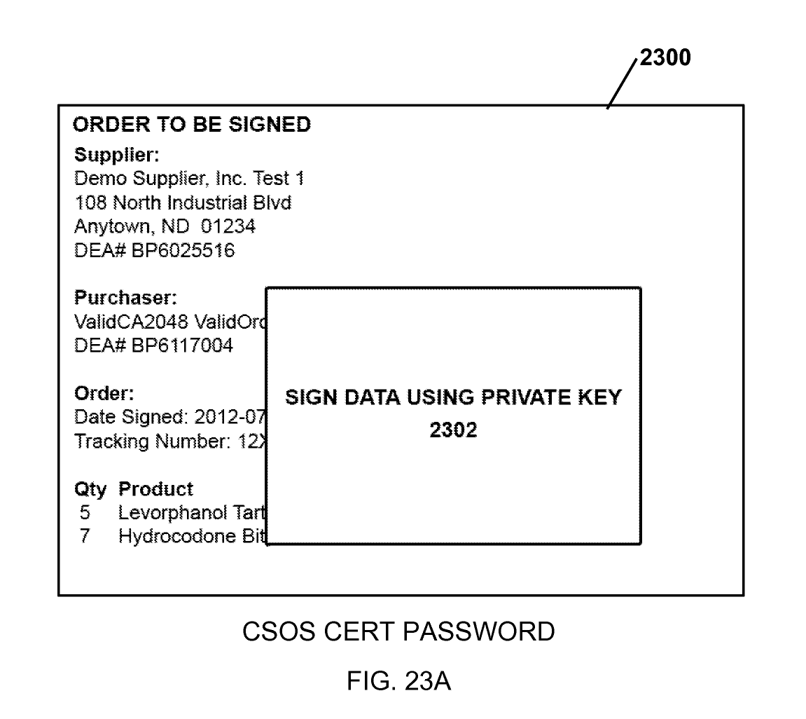

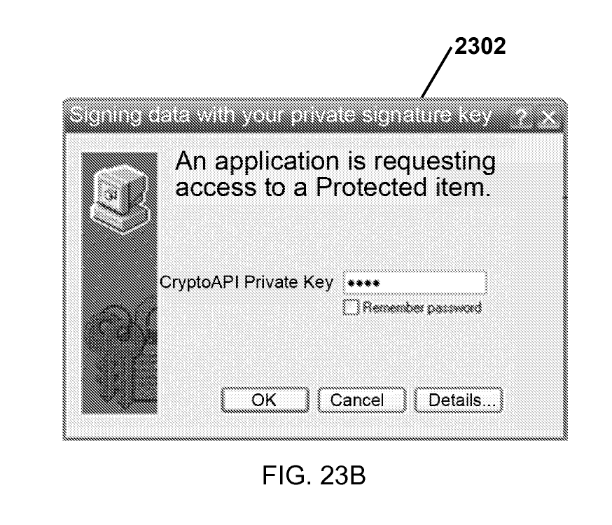

FIG. 22A provides a screenshot 2200 wherein a popup 2202 is used to show a list of locally installed digital certificates from which the signer selects one to be used sign the order in accordance with embodiments of the present disclosure. Screenshot 2200 behind the Popup Box 2202 are all the details associated with the controlled substance order. This is the information that is required to verify the order. The popup box in FIG. 22B allows a digital certificate to be selected from among all digital certificates the user has installed on his system, and used to sign the order. When the user selects OK after selecting the appropriate digital certificate, an online ordering system certification password is requested as shown in FIGS. 23A-23B.

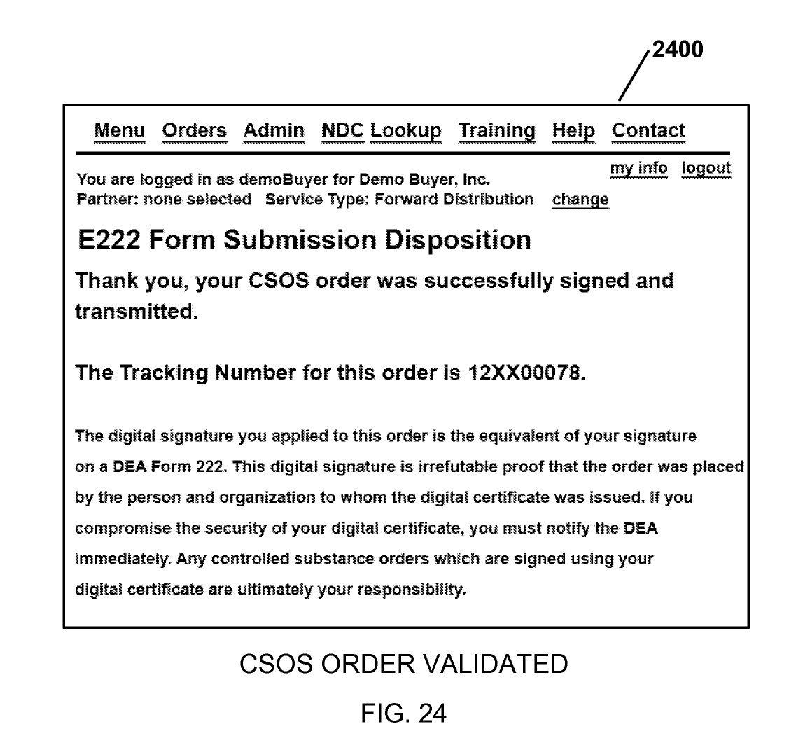

FIG. 23A provides a screenshot 2300 wherein a popup 2302 requests the signer to enter a password allowing the locally installed digital certificate to be used to digitally sign the order in accordance with embodiments of the present disclosure. A popup 2302 as illustrated in FIG. 23B allows a user to digitally sign an order for controlled substances. Behind the popup box 2302 are the details of the controlled substance order. When the proper password is submitted and the digital certificate is validated a screenshot such as that provided by FIG. 24 may be presented.

FIG. 24 provides a screenshot 2400 of the results of the digital signature validation process and preliminary order confirmation in accordance with embodiments of the present disclosure. Screenshot 2400 shows an online order being validated. This screenshot tells the user the status of the order wherein the controlled substance order was successfully signed and transmitted and a tracking number is associated with it. Further details associated with the electronic form 222 may be provided.

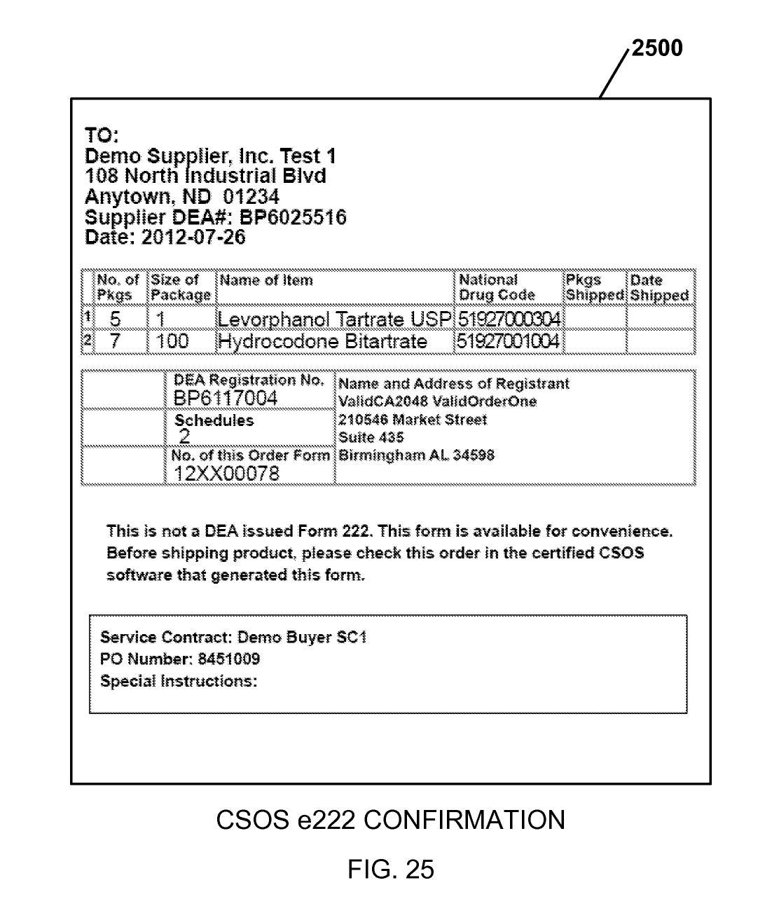

FIG. 25 provides a screenshot 2500 of the order confirmation in the form of an electronic form 222 produced by the system in accordance with embodiments of the present disclosure. Electronic form 222 may be provided to notify the supplier of an incoming order and supplement the electronic tracking of the controlled substances with paper tracking, if needed.

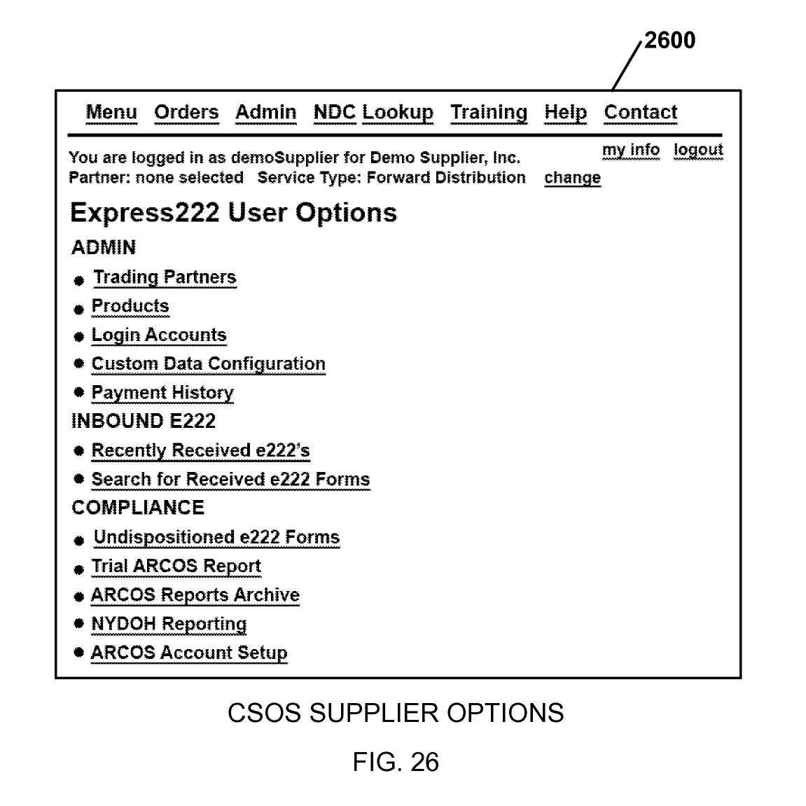

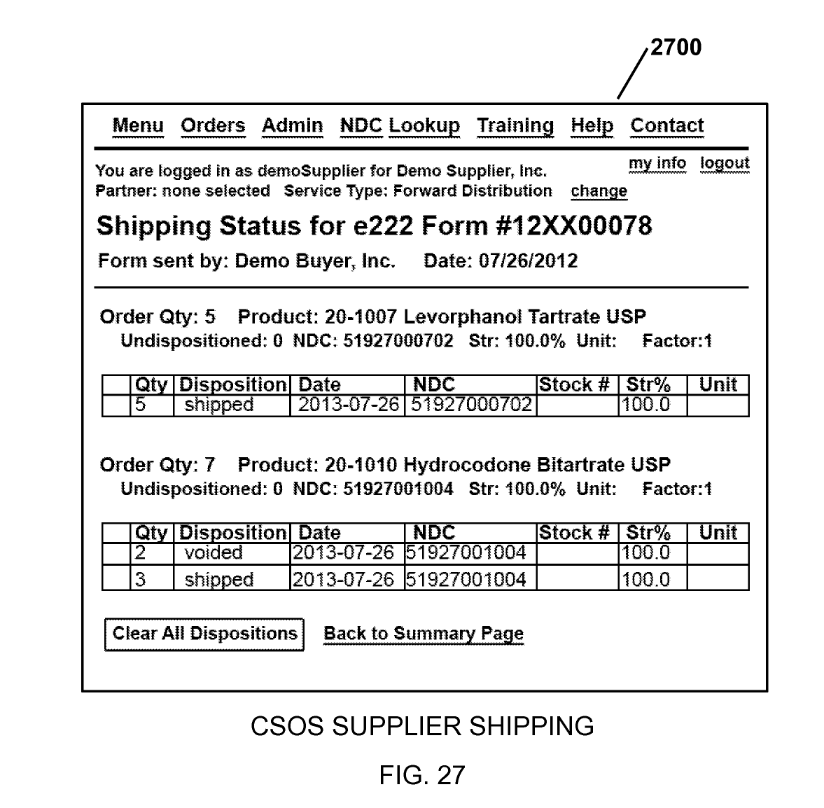

FIG. 26 provides a screenshot of 2600 of the controlled substance order receiver/supplier's options in accordance with the embodiments of the present disclosure. Screen 2600 presents a menu containing administrative options, inbound order management options, compliance options, and various other general system options. If the supplier selects the “Undispositioned e222 Forms” option, a screenshot such as that provided in FIG. 27 may be presented.

FIG. 27 provides a screenshot 2700 of the CSOS supplier's shipping status of electronic form 222. This allows the supplier to indicate the quantities and dates that ordered items were shipped or voided, so that the shipping information may be reported in accordance with DEA regulations.

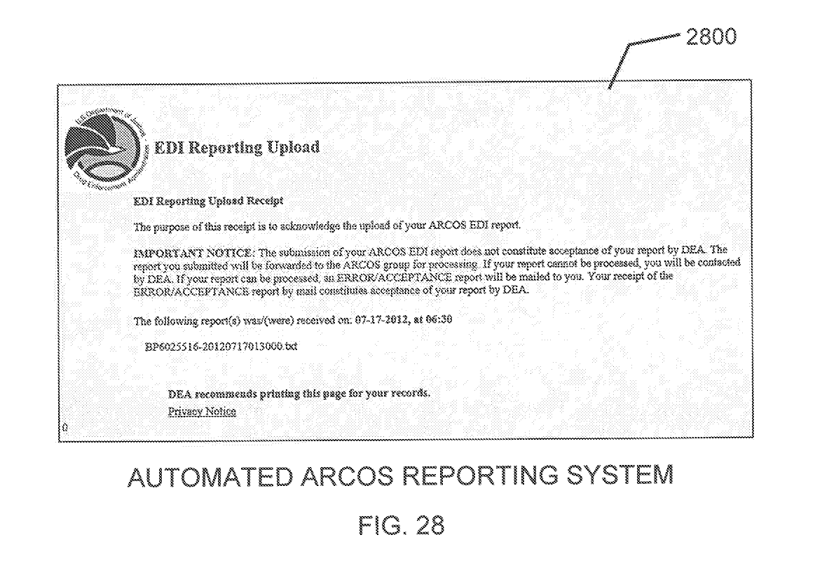

FIG. 28 provides a screenshot 2800 detailing the response from the DEA reporting system upon automated transmission of daily reports about controlled substance shipments in accordance with embodiments of the present disclosure. This report may be automatically generated and reported to the agency and a confirmation of this report may be provided by this automated report file creation screenshot.

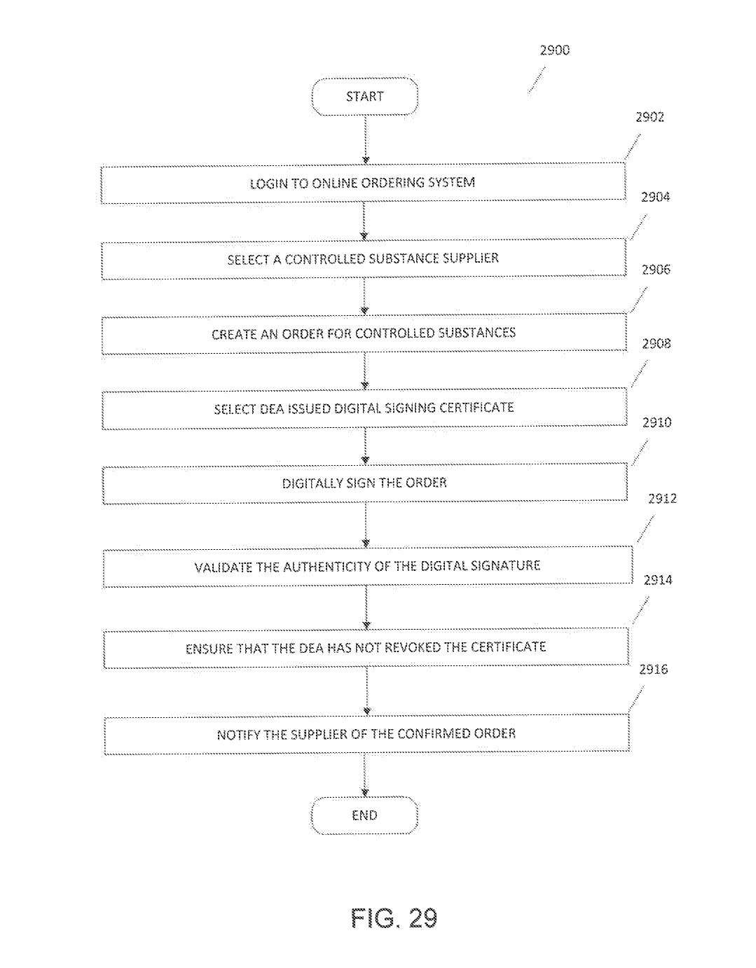

FIG. 29 provides a logic flow diagram associated with the process of placing an order for a controlled substance in accordance with embodiments of the present disclosure. Operations 2900 begin in Block 2902, wherein a user may log on to a network site via the interface such as that discussed with reference to FIGS. 17 and 18. In Block 2904, after successful login the user may select a supplier from whom to order controlled substances. In Block 2906, the user may interactively create a sales order for controlled substances such as discussed with reference to FIGS. 19, 20, and 21. In Block 2908 a user may select a digital certificate to be associated with the order. At the same time, the order may be digitally signed in Block 2910. Then the order with the proper digital certificate and signature may be verified in Blocks 2912 and 2914. In Block 2916 the supplier is notified of the verified order. Only a properly verified order may be executed and fulfilled.

The data flow charts, logic flow diagrams, screen shots, and block diagrams in the FIGS. illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the FIGS. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The disclosure can take the form of an entirely hardware embodiment, an entirely software embodiment or an embodiment containing both hardware and software elements. In a preferred embodiment, the disclosure is implemented in software, which includes but is not limited to firmware, resident software, microcode, etc.

Furthermore, the disclosure can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times, code must be retrieved from bulk storage during execution.

Input/output or I/O devices (including: but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As one of average skill in the art will appreciate, the term “substantially” or “approximately,” as may be used herein provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled,” as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled.” As one of average skill in the art will further appreciate, the term “compares favorably,” as may be used herein, indicates that a comparison between two or more elements, items, signals, etc. provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

In summary, embodiments of the present disclosure provide a Controlled Substance (CS) transfer management system that includes: 1) a client interface operable to be hosted on an Internet site, the client interface operable to receive an order for a controlled substance; 2) a server operable to support the client interface, perform signature validation functions, including checking a revocation list via the external agency validation server; 3) a secured database server wherein signed validated orders are posted for fulfillment and reporting; and 4) an interface an external agency validation server, the server operable to establish an LDAP connection to the external agency validation server.

1. A system for secure transfer management of a controlled substance comprising:
a network;
a server connected to the network, programmed to:
receive, at the server, a set of controlled substance transfer requests;
retrieve, at the server, a digital signature;
generate, at the server, a set of digitally signed messages from the set of controlled substance transfer requests and the digital signature;
generate, at the server, a first set of hash values from the set of digitally signed messages;
compare, at the server, a second set of hash values to the first set of hash values; and,
generate, at the server, a set of encoded orders from the set of digitally signed orders when the first set of hash values matches the second set of hash values.

2. The system of claim 1, further comprising a buyer device connected to the network, programmed to transmit the set of controlled substance transfer requests to the server.

3. The system of claim 1, further comprising a supplier device connected to the network; wherein the server is further programmed to transmit, from the server to the supplier device, the set of encoded orders.

4. The system of claim 1, wherein the server is further programmed to:
generate, at the server, a set of transaction reports from the set of encoded orders; and,
transmit, from the server to a regulator, the set of transaction reports.

5. The system of claim 1, wherein each of the set of controlled substance transfer requests is an electronic form 222.

6. The system of claim 1, wherein the digital signature is a public key infrastructure certificate.

7. The system of claim 1, further comprising a Federal Information Processing Standards security module stored on the server.

8. The system of claim 1, wherein the server is further programmed to:
retrieve, at the server, a set of digital signatures; and,
generate, at the server, the set of digitally signed messages from the set of digital signatures and the set of controlled substance transfer requests.

9. The system of the claim 1, wherein the server is further programmed to generate, at the server, the set of controlled substance transfer requests.

10. The system of claim 1, wherein the set of controlled substance transfer requests is a set of electronic controlled substance prescriptions.

11. The system of claim 10, wherein the server is further programmed to:
generate, at the server, the set of electronic controlled substance prescriptions for approval;
generate, at the server, a set of prescription data from the set of electronic controlled substance prescriptions; and,
generate, at the server, a prescription log from the set of prescription data.

12. A method for secure transfer management of a controlled substance related to a set of buyers, the secure transfer management being first between a set of buyer devices associated respectively with the set of buyers and a server, and thereafter between the server and a set of supplier devices associated respectively with a set of suppliers, the method comprising the steps of:
receiving, at the server from the set of buyer devices, a set of controlled substance transfer requests;
retrieving, at the server, a set of digital signatures;
generating, at the server, a set of digitally signed messages from the set of controlled substance transfer requests and the set of digital signatures;
generating, at the server, a first set of hash values from the set of digitally signed messages;
comparing, at the server, a second set of hash values to the first set of hash values;
generating, at the server, a set of encoded orders from the set of digitally signed orders when the first set of hash values matches the second set of hash values; and,
transmitting, from the server to the set of supplier device, the set of encoded orders.

13. The method of claim 12, further comprising the steps of:
generating, at the server, a set of transaction reports from the set of encoded orders; and,
transmitting, from the server to a regulator, the set of transaction reports.

14. The method of claim 12, further comprising the steps of generating, at the server, the set of controlled substance transfer requests.

15. The method of claim 12, wherein the set of controlled substance transfer requests is a set of electronic controlled substance prescriptions, and wherein the method further comprises the steps of:
generating, at the server, the set of electronic controlled substance prescriptions for approval;
generating, at the server, a set of prescription data from the set of electronic controlled substance prescriptions; and,
generating, at the server, a prescription log from the set of prescription data.

16. A controlled substance ordering system comprising:
a network;
a set of buyer devices connected to the network;
a set of supplier devices connected to the network;
a server connected to the network, programmed to:
receive, at the server from the set of buyer devices, a set of controlled substance transfer requests;
retrieve, at the server, a set of digital signatures;
generate, at the server, a set of digitally signed messages from the set of controlled substance transfer requests and the set of digital signatures;
generate, at the server, a first set of hash values from the set of digitally signed messages;
compare, at the server, a second set of hash values to the first set of hash values;
generate, at the server, a set of encoded orders from the set of digitally signed orders when the first set of hash values matches the second set of hash values; and,
transmit, from the server to the supplier device, the set of encoded orders.

17. The controlled substance ordering system of claim 16, wherein the server is further programmed to:
generate, at the server, a set of transaction reports from the set of encoded orders; and,
transmit, from the server to a regulator, the set of transaction reports.

18. The controlled substance ordering system of claim 17, wherein the server is further programmed to retrieve, at the server from the regulator, a digital signature revocation list.

19. The controlled substance ordering system of claim 16, wherein each of the set of controlled substance transfer requests is an electronic form 222.

20. The controlled substance ordering system of claim 16, further comprising a Federal Information Processing Standards validated security module stored on the server.
